(19) United States
(12) Patent Application Publication
(10) Pub. No.: US 2019/0003341 A1
(43) Pub. Date: Jan. 3, 2019

(54) HYBRID ENERGY SYSTEM

(71) Applicant: Apollo Hybrid, Inc., Loveland, CO (US)

(72) Inventors: Edward Aaron VanDyne, Loveland, CO (US); Volker Schumacher, Sassenburg (DE)

(73) Assignee: Apollo Hybrid, Inc., Loveland, CO (US)

(21) Appl. No.: 15/993,079

(22) Filed: May 30, 2018

Related U.S. Application Data
(63) Continuation-in-part of application No. 15/123,750, filed on Sep. 6, 2016.
(60) Provisional application No. 61/966,768, filed on Mar. 4, 2014.
(60) Provisional application No. 62/512,565, filed on May 30, 2017.

(51) Int. Cl. F01K 7/02; F02G 3/02; F02G 5/02; F03G 6/00; F01K 13/00

(52) U.S. Cl. CPC F01K 7/025; F02G 3/02; F02G 2270/70; F03G 6/003; F01K 13/00; F02G 5/02

(57) ABSTRACT

Implementations described and claimed herein provide systems and methods for providing energy to a defined space, such as a house or other building. In one implementation, thermal energy is received from a solar power source at a solar boiler, and steam is generated from the thermal energy using the solar boiler. One or pistons of a steam engine is driven with a pressure from the steam. The steam engine outputs a first waste heat. The first waste heat is received from the steam engine at a chiller. The chiller generates conditioned air from the first waste heat.

### CROSS-REFERENCE TO RELATED APPLICATIONS

The present application is a continuation-in-part of U.S. patent application Ser. No. 15/123,750, entitled “Liquid Piston Engine” and filed Sep. 6, 2016, which is a National Stage application of International Patent Corporation Treaty Patent Application No. PCT/US2015/018829, entitled “Liquid Piston Engine” and filed Mar. 4, 2015, which claims priority under 35 U.S.C. § 119(e) to U.S. Provisional Patent Application No. 61/966,768, entitled “Water Piston Engine” and filed on Mar. 4, 2014.

The present application further claims priority under 35 U.S.C. § 119(e) to U.S. Provisional Patent Application 62/512,565, entitled “Hybrid Energy System” and filed May 30, 2017.

Each of the foregoing applications is hereby incorporated by reference in its entirety into the present application.

### TECHNICAL FIELD

Aspects of the present disclosure relate to systems and methods for providing energy to a defined space, among other functions, and more particularly to systems and methods for generating one or more energy outputs to a building, such as a home.

### BACKGROUND

Generators provide electrical power for a myriad of uses, such as powering a home, building, or power grid. Typically, a generator converts mechanical energy into electrical energy, with the source of mechanical energy varying tremendously. For example, steam engines may convert pressure from steam into mechanical energy using metallic pistons and a crankshaft. However, generating power using such sources of mechanical energy are often plagued by high complexity and production of high levels of pollution and greenhouse gases or are otherwise impractical or expensive. Moreover, many conventional systems require regular maintenance causing interruptions in power output as a result of the limitations of the mechanical system design.

It is with these observations in mind, among others, that various aspects of the present disclosure were conceived and developed.

### SUMMARY

Implementations described and claimed herein provide systems and methods for proving energy to a defined space. In one implementation, thermal energy is received from a solar power source at a solar boiler, and steam is generated from the thermal energy using the solar boiler. One or pistons of a steam engine is driven with a pressure from the steam. The steam engine outputs a first waste heat. The first waste heat is received from the steam engine at a chiller. The chiller generates conditioned air from the first waste heat.

In another implementation, a first boiler having a first heat exchanger generates a first heat output from a first energy source having a first temperature. A second boiler having a second heat exchanger generates a second heat output from a second energy source having a second temperature. The second heat output supplements the first heat output to form a two-stage boiler having a cogenerated heat output. The second heat exchanger is disposed above the first heat exchanger, the first energy source is different from the second energy source, and the first temperature is lower than the second temperature. A piston steam engine is driven by steam generated by the cogenerated heat output.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is a schematic drawing of an example system for generating substantially continuous power, the system having a two-way liquid turbine with two water piston tanks.

FIG. 2 is a schematic drawing of another example system for generating substantially continuous power, the system having a one-way liquid turbine with two water piston tanks.

FIG. 3 is a schematic drawing of another example system for generating substantially continuous power, the system having an impulse type liquid turbine with a three water piston tanks.

FIG. 4 is a schematic drawing of an example system for water purification and substantially continuous power generation, the system having a two-way liquid turbine with a two water piston tanks.

FIG. 5 is a schematic drawing of another example system for generating substantially continuous power, the system having a two-way liquid turbine with pressure created from combustion.

FIG. 6 illustrates example operations for generating substantially continuous power.

FIG. 7 illustrates an example hybrid energy system implemented during a period of sunlight.

FIG. 8 illustrates the hybrid energy system implemented during a period without sunlight.

FIG. 9 shows an example network environment with an application running on a server or other computing device for controlling a hybrid energy system over a network.

FIG. 10 depicts an example computing system that may implement various systems and methods discussed herein.

### DETAILED DESCRIPTION

Aspects of the present disclosure involve systems and methods for generating substantially continuous power. In one particular aspect, a heat source, such as solar panel(s) or a combustion chamber, collects thermal energy to drive one or more types of liquid turbines using steam pressure. Pistons formed by a liquid, such as water, are pressurized by steam entering into a tank. The steam pressure displaces the liquid piston from the tank into an outlet tube. The liquid flows under pressure via the outlet tube to a hydraulic device, such as a liquid turbine, pump, hydraulic motor, or the like, where the energy generated by the pressurized flow is converted into electrical power and/or mechanical power. A plurality of tanks may be utilized with the liquid flowing back and forth between the tanks to create substantially continuous power. The liquid piston engine system harnesses steam or other pressurized gas into power at an efficiency level of approximately twice the power per dollar of system cost as conventional systems.

In some aspects, the heat source is configured to maximize the collection of thermal energy and resist external elements (e.g., weather). For example, where solar power is utilized as a heat source, one or more solar panels are configured to maximize sun exposure, thereby increasing the solar energy harnessed. The solar panels may be moved in various directions and/or orientations depending on the position of the sun for direct sun exposure. Similarly, the solar panels may be moved to an orientation and/or a cover or similar reflective device may be deployed to protect the solar panels against external environmental elements.

Some aspects of the presently disclosed technology involve remote monitoring and management of one or more liquid piston engine systems. A user, such as a client or an administrator of an energy service, may remotely monitor and manage one or more liquid piston engine systems by using data obtained from one or more sensors and/or one or more databases or other sources over a network. For example, sensors and/or data sources may provide information regarding weather conditions, time of sunrise and sunset, and the like. Using this information, the one or more liquid piston engine systems may be remotely turned on/off and the heat source controlled. Alternatively or additionally, the liquid piston engine systems may obtain such information to automatically respond accordingly. Other operational and/or output parameters of the liquid piston engine(s) may be received over the network to generate analytics or permit control over the various operations of the liquid piston engine system. The analytics may be used to demonstrate or otherwise monitor a value of the liquid piston engine system, troubleshoot, adjust the operations of the liquid piston engine system, and/or the like.

The various systems and methods disclosed herein generally provide for generating substantially continuous electrical and/or mechanical power. The implementations discussed herein provide example configurations having liquid turbines with one or more liquid piston tanks where the liquid is displaced with pressurized vapor of such liquid. However, it will be appreciated by those skilled in the art that the presently disclosed technology is applicable to other configurations, other liquids, or other pressurized gases.

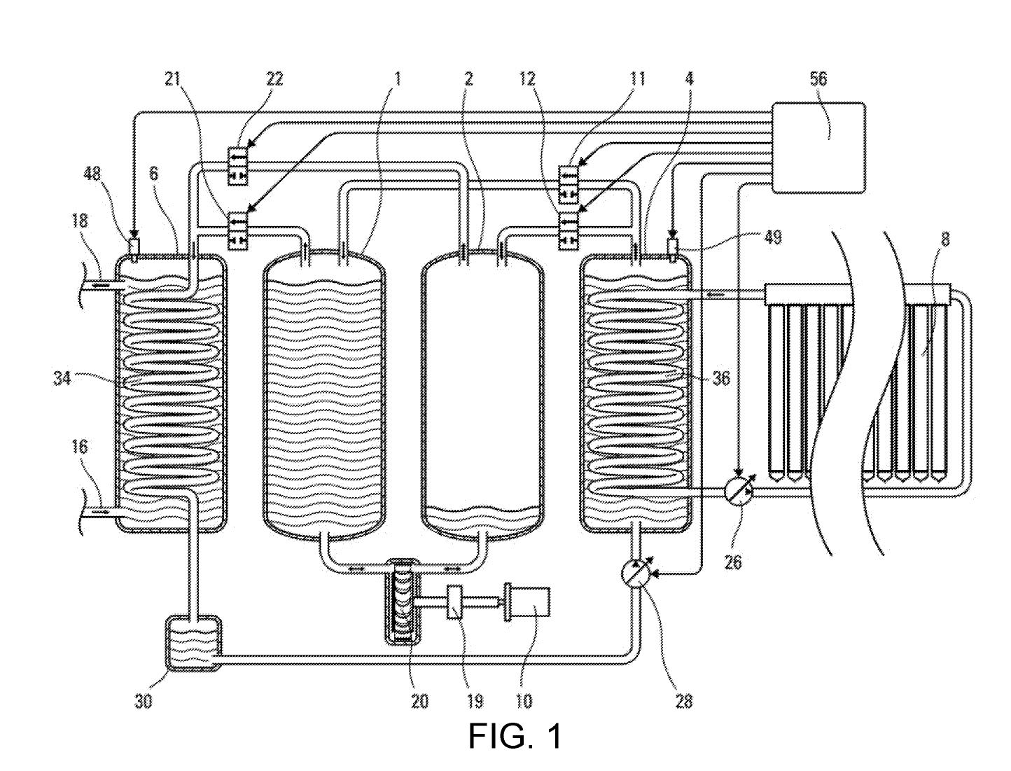

For a detailed description of example systems for generating substantially continuous power, reference is made to FIGS. 1-5. Turning first to FIG. 1, in one implementation, a liquid piston engine system includes a plurality of liquid piston tanks (e.g., a first liquid piston tank 1 and a second piston tank 2) connected to a turbine 20. It will be appreciated that the turbine 20 may be replaced with a pump, hydraulic motor, or similar device for extracting and converting energy from fluid flow.

The turbine 20 is a rotary mechanical device configured to spin upon application of a force created by a flow of liquid between the liquid piston tanks 1 and 2. The liquid may be, without limitation, water, a mixture of water and antifreeze, ethanol, methanol, refrigerants, and/or the like. In the example implementation shown in FIG. 1, the turbine 20 is a two-way liquid turbine, which turns in the same direction independent of the direction of the flow of liquid. Stated differently, regardless of whether the liquid is flowing from the liquid piston tank 1 to the liquid piston tank 2 or the reverse, the turbine 20 will consistently rotate in the same direction.

The turbine 20 is connected to and turns a generator 10, thereby generating electrical power and/or mechanical power. The electrical power may be output from the generator 10 for storage in one or more batteries or fed into a system, such as a home or building electrical system or a power grid. The mechanical power may be used, for example, to operate machinery in a factory.

The generator 10 may be either a direct current (DC) or alternating current (AC) generator. In one implementation, the generator 10 is an asynchronous AC motor, which requires no circuitry to become a generator when connected to a system, such as a power grid. It will be appreciated that the generator 10 may be a similar motor to an asynchronous AC motor or other type of generator.

A heat source creates steam, which may be converted into energy for driving the turbine 20 using the liquid piston tanks 1 and 2. In one implementation, the heat source includes a solar heating tank 4 having a heat exchanger 36. A solar panel array 8 collects solar energy, which heats a high temperature fluid, such as ethylene glycol, oil, or the like. A variable flow pump 26 directs the high temperature fluid through the solar panel array 8 for heating and into the heat exchanger 36 where the liquid is boiled in the solar heating tank 4. As the liquid is boiled in the solar heating tank 4, steam is created.

Steam pressure created by the solar heating tank 4 may be directed into the liquid piston tank 1 using a steam inlet valve 11 and the liquid piston tank 2 using a steam inlet valve 12. The steam inlet valves 11 and 12 may each be two-way valves configured to open and close, allowing the steam pressure to flow in only one direction from the solar heating tank 4 to the liquid piston tanks 1 and 2, respectively.

To release steam pressure from the liquid piston tanks 1 and 2, steam outlet valves 21 and 22 direct steam pressure into a heat exchanger, such as a condenser 34, housed within a hot water heater 6. The steam outlet valves 21 and 22 may each be two-way valves configured to open and close, allowing the steam pressure to flow in only one direction from the liquid piston tanks 1 and 2, respectively, to the condenser 34. In one implementation, cold water enters the hot water heater 6 via a pipe 16 and hot water exits the hot water heater 6 via a pipe 18. The temperature of the water within the hot water heater 6 may be maintained to return the steam within the condenser 34 to liquid form. For example, where the liquid within the liquid piston tanks 1 and 2 is water and the steam is boiled from water, the temperature of the water within the hot water heater 6 may be maintained below approximately 90° C. After the steam is condensed, the liquid drains from the condenser 34 into a condensate tank 30. As the liquid level lowers within the solar heating tank 4, the liquid may be replenished from the condensate tank 30 via a variable flow pump 28.

In one implementation, the turbine 20 is disposed below and between the liquid piston tanks 1 and 2. While the liquid piston engine system is off, liquid held in the liquid piston tanks 1 and 2 is even, with both of the liquid piston tanks 1 and 2 approximately half full. To start the liquid piston engine system, the steam inlet valve 12 is opened, directing the steam pressure from the solar heating tank 4 into the liquid piston tank 2. The pressure of the steam in the liquid piston tank 2 displaces the level of liquid downwardly through the turbine 20 and into the liquid piston tank 1. As the liquid is displaced from the liquid piston tank 2 into the liquid piston tank 1, the steam outlet valve 21 is opened to release steam from the liquid piston tank 1 into the condenser 34. The flow of liquid from the liquid piston 2 to the liquid piston 1 turns the turbine 20, which turns the generator 10 to create electrical and/or mechanical power.

When the liquid piston tank 2 is empty and thus the liquid piston tank 1 is full, the steam inlet valve 12 and the steam outlet valve 21 are closed, and the steam inlet valve 11 and the steam outlet valve 22 are opened, thereby reversing the flow of liquid. When the flow of liquid reverses, there may be a brief interruption of power output from the generator 10. Accordingly, in one implementation, a flywheel 19 is disposed along a shaft connecting the turbine 20 and the generator 10 to minimize the interruption in power output. Alternatively or additionally, the turbine 20 may include a relatively heavy wheel to reduce the interruption on power output.

In one implementation, when the steam inlet valve 11 is opened, steam pressure is directed from the solar heating tank 4 into the liquid piston tank 1. The pressure of the steam in the liquid piston tank 1 displaces the level of liquid downwardly through the turbine 20 and into the liquid piston tank 2. As the liquid is displaced from the liquid piston tank 1 into the liquid piston tank 2, the steam outlet valve 22 is opened to release steam from the liquid piston tank 2 into the condenser 34. The flow of liquid from the liquid piston 1 to the liquid piston 2 turns the turbine 20, which turns the generator 10 to create electrical and/or mechanical power. When the liquid piston tank 1 is empty and thus the liquid piston tank 2 is full, the steam inlet valve 11 and the steam outlet valve 22 are closed, and the steam inlet valve 12 and the steam outlet valve 21 are opened, thereby reversing the flow of liquid.

Thus, the liquid flows back and forth between the liquid piston tank 1 and the liquid piston tank 2, creating a closed loop two tank system. The turbine 20 flows in the same direction independent of which way the liquid is flowing between the liquid piston tanks 1 and 2. As such, the turbine 20 continues to turn the generator 10, thereby creating substantially continuous power with any interruptions in power output minimized by the flywheel 19, for example.

In one implementation, to optimize total system efficiency, the steam inlet valve 11 is open until the liquid is displaced partly down the liquid piston tank 1. The steam inlet valve 11 is then closed, trapping steam in the liquid piston tank 1. The trapped steam expands in the liquid piston tank 1 as the remaining liquid is displaced, thereby utilizing more available energy of the steam. Stated differently, limiting steam input to a first portion of a liquid piston stroke and allowing the steam to expand to a lower pressure at a bottom of the liquid piston tanks 1 or 2, increases the total efficiency of the liquid piston engine system. In some implementations, there may be an increase of approximately 20% efficiency in power output. The steam inlet valve 12 may be opened and closed similarly during displacement of the liquid in the liquid piston tank 2. The closer the steam is to atmospheric pressure while the turbine 20 turns, the higher the total system efficiency. In one implementation, there is some remaining steam pressure in the liquid piston tanks 1 or 2 when one of the steam outlet valves 21 or 22 is open, which keeps the liquid moving through the turbine 20 while overcoming the head of liquid building in the nearly full liquid piston tank 1 or 2.

During high efficiency operation, when the steam inlet valve 11 is opened, steam pressure is directed from the solar heating tank 4 into the liquid piston tank 1. The pressure of the steam in the liquid piston tank 1 displaces the level of liquid downwardly through the turbine 20 and into the liquid piston tank 2. When the liquid in the liquid piston tank 1 is partially displaced, the steam inlet valve 11 is closed, allowing the steam to expand to a lower pressure than the pressure of the steam upon exiting the solar heating tank 4. As the liquid is displaced from the liquid piston tank 1 into the liquid piston tank 2, the steam outlet valve 22 is opened to release steam from the liquid piston tank 2 into the condenser 34. The flow of liquid from the liquid piston 1 to the liquid piston 2 turns the turbine 20, which turns the generator 10 to create electrical and/or mechanical power. When the liquid piston tank 1 is empty and thus the liquid piston tank 2 is full, the steam outlet valve 22 is closed, and the steam inlet valve 12 and the steam outlet valve 21 are opened. The steam pressure is then directed from the solar heating tank 4 into the liquid piston tank 2, which similarly displaces the liquid as described with respect to the liquid piston tank 1.

To further increase efficiency, in one implementation, the steam flow to the liquid piston tank 1 or 2 may be combined with heated liquid from the solar heating tank 4. The heated liquid may have a temperature, for example, of approximately 150° C. Introducing the heated liquid into an insulated area of the liquid piston tank 1 or 2 may reduce the quantity of steam needed for transfer between the liquid piston tanks 1 and 2. Once the liquid is displaced within the liquid piston tank 1 or 2, the pressure decreases, and more of the heated liquid evaporates, thereby maintaining the pressure as the remaining liquid in the liquid piston tank 1 or 2 is displaced. The steam and/or the heated liquid is no longer introduced into the liquid piston tank 1 or 2 once the liquid is partially displaced, as described above to permit the steam to expand to a lower pressure and the heated liquid to evaporate. This wet steam process utilizes more of the total energy available to the liquid piston engine system by reducing the energy directed into the liquid within the solar heating tank 4 for a given amount of the power of the turbine 20. Thus, a power versus heat energy ratio is increased.

Over time, steam from the solar heating tank 4 condenses inside the liquid piston tank 1 or 2. The condensed steam within the liquid piston tanks 1 and 2 does not reach the condenser 34, thereby reducing the level of liquid in the solar heating tank 4. The excess liquid may cause one or both of the liquid piston tanks 1 and 2 to overflow. For example, where the liquid piston tank 1 is empty and the liquid piston tank 2 is full and includes excess liquid, the excess liquid will overflow from the liquid piston tank 2 through the steam outlet valve 22 into the condenser 34. The liquid drains through the condenser 34 into the condensate tank 30 where the liquid is pumped back into the solar heating tank 4 using the variable flow pump 28.

In one implementation, steam remaining in the liquid piston tanks 1 and 2 at a final portion of a piston stroke is condensed in the condenser 34 or utilized in another way. The secondary use of the steam energy creates a combined heat and power system increasing the total efficiency of the liquid piston engine system to approximately 90%. Where the heat input is solar energy, a very high efficiency, low carbon system is provided for heating and powering various systems, including, but not limited to, residential, retail, industrial, office, power grids, and/or other systems.

The generator 10 will output substantially continuous power as long as the solar panel array 8 is able to collect sufficient thermal energy to boil the liquid in the solar heat tank 4 to a sufficient pressure. The liquid will flow back and forth between the liquid piston tanks 1 and 2 through the turbine 20, thereby turning the generator 10 and generating power. In one implementation, where the thermal energy collected by the solar panel array 8 declines to a level that no longer produces sufficient steam pressure in the solar heat tank 4, some or all of the valves 11, 12, 21, and 22 are opened to direct the remaining steam to the condenser 34.

The generator 10 outputs different levels of power depending on a speed of the flow of liquid through the turbine 20. The speed of the flow of liquid between the liquid piston tanks 1 and 2 through the turbine 20 depends on a heat input rate from the heat exchanger 36 and therefore the rate of steam creation in the solar heat tank 4. In one implementation, the rate of heat input provided to the heat exchanger 36 from the solar panel array 8 varies throughout the course of the day, as the position of the sun changes from sunrise to sunset, as well as during weather events. As such, the valves 11, 12, 21, and 22 may be opened and closed, as well as other operations of the liquid piston engine system controlled, depending on the rate of heat input.

In one implementation, the operations of the liquid piston engine system are controlled with a controller 56. For example, the controller 56 may control the operation of the valves 11, 12, 21, 22, 26, and 28. In one implementation, the controller 56 is in communication with one or more sensors to collect data regarding the operation of the liquid piston engine system. For example, pressure sensors 48 and 49 may detect a pressure in the hot water heater 6 and the solar heating tank 4, respectively, which is then communicated to the controller 56. In one implementation, the controller 56 is in communication with a network for remote monitoring and management of the liquid piston engine system, as described herein.

The various components of the liquid piston engine system may be made from low-cost materials, which combined with the increased efficiency in power generation magnifies the value of the liquid piston engine system. For example, the cost per kilowatt of the liquid piston engine system may be approximately one half to one fifth of the cost of a conventional system. The integrated nature of the liquid piston engine system facilitates mass production, thereby reducing installation cost and complexity and improving quality and efficacy of the product received by an end user.

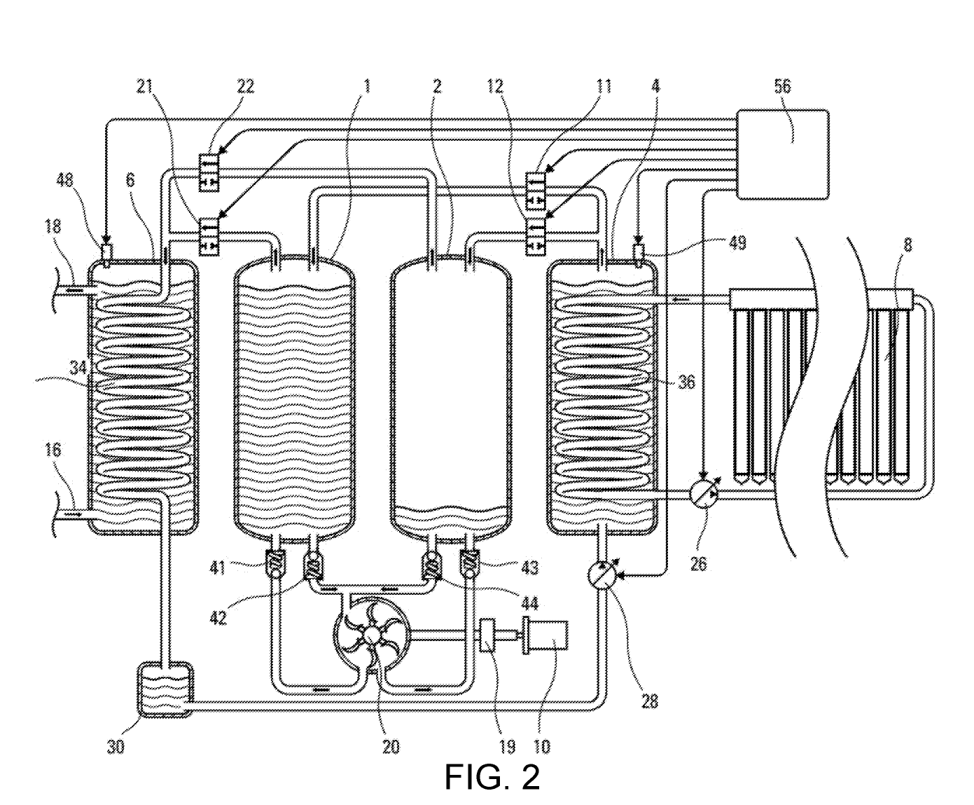

Referring to FIG. 2, the liquid piston engine system includes features similar to those described with respect to FIG. 1. In one implementation, the turbine 20 is a one-way turbine configured to turn in the direction of the flow of fluid, which is consistently one direction, as illustrated in FIG. 2. The liquid piston engine system further includes output check valves 42 and 44 for the liquid piston tanks 1 and 2, respectively, and return check valves 41 and 43 or the liquid piston tanks 1 and 2, respectively. The check valves 41-44 are configured to ensure that the turbine 20 consistently turns the generator 10 in the same direction.

In one implementation, the turbine 20 is disposed below and between the liquid piston tanks 1 and 2 with the output check valves 42 and 44 disposed along a path of the flow of liquid from the liquid piston tanks 1 and 2 to the turbine 20 and the return check valves 41 and 43 disposed along a path of the flow of liquid from the turbine 20 to the liquid piston tanks 1 and 2.

To start the liquid piston engine system, the steam inlet valve 12 is opened, directing the steam pressure from the solar heating tank 4 into the liquid piston tank 2. The pressure of the steam in the liquid piston tank 2 displaces the level of liquid downwardly through the output check valve 44 to the turbine 20. The liquid exits the turbine 20 and flows through the return check valve 41 into the liquid piston tank 1. As the liquid is displaced from the liquid piston tank 2 into the liquid piston tank 1, the steam outlet valve 21 is opened to release steam from the liquid piston tank 1 into the condenser 34. The flow of liquid from the liquid piston 2 to the liquid piston 1 turns the turbine 20, which turns the generator 10 to create electrical and/or mechanical power.

When the liquid piston tank 2 is empty and thus the liquid piston tank 1 is full, the steam inlet valve 12 and the steam outlet valve 21 are closed, and the steam inlet valve 11 and the steam outlet valve 22 are opened, thereby reversing the flow of liquid. When the flow of liquid reverses, there may be a brief interruption of power output from the generator 10. Accordingly, in one implementation, the flywheel 19 is disposed along a shaft connecting the turbine 20 and the generator 10 to minimize the interruption in power output. Alternatively or additionally, the turbine 20 may include a relatively heavy wheel to reduce the interruption on power output.

In one implementation, when the steam inlet valve 11 is opened, steam pressure is directed from the solar heating tank 4 into the liquid piston tank 1. The pressure of the steam in the liquid piston tank 1 displaces the level of liquid downwardly through the output check valve 42 to the turbine 20. The liquid exits the turbine 20 and flows through the return check valve 43 into the liquid piston tank 2. As the liquid is displaced from the liquid piston tank 1 into the liquid piston tank 2, the steam outlet valve 22 is opened to release steam from the liquid piston tank 2 into the condenser 34. The flow of liquid from the liquid piston 1 to the liquid piston 2 turns the turbine 20, which turns the generator 10 to create electrical and/or mechanical power. When the liquid piston tank 1 is empty and thus the liquid piston tank 2 is full, the steam inlet valve 11 and the steam outlet valve 22 are closed, and the steam inlet valve 12 and the steam outlet valve 21 are opened, thereby reversing the flow of liquid.

Thus, the liquid flows back and forth between the liquid piston tank 1 and the liquid piston tank 2 via the check valves 41-44. The turbine 20 flows in the same direction independent of which way the liquid is flowing between the liquid piston tanks 1 and 2. As such, the turbine 20 continues to turn the generator 10, thereby creating substantially continuous power with any interruptions in power output minimized by the flywheel 19.

In one implementation, to optimize total system efficiency, the steam inlet valve 11 is open until the liquid is displaced partly down the liquid piston tank 1. The steam inlet valve 11 is then closed, trapping steam in the liquid piston tank 1. The trapped steam expands in the liquid piston tank 1 as the remaining liquid is displaced, thereby utilizing more available energy of the steam. The steam inlet valve 12 may be opened and closed similarly during displacement of the liquid in the liquid piston tank 2. The closer the steam is to atmospheric pressure while the turbine 20 turns, the higher the total system efficiency. In one implementation, there is some remaining steam pressure in the liquid piston tanks 1 or 2 when one of the steam outlet valves 21 or 22 is open, which keeps the liquid moving through the turbine 20 and the check valves 41-44 while overcoming the head of liquid building in the nearly full liquid piston tank 1 or 2.

During high efficiency operation, when the steam inlet valve 11 is opened, steam pressure is directed from the solar heating tank 4 into the liquid piston tank 1. The pressure of the steam in the liquid piston tank 1 displaces the level of liquid downwardly through the output check valve 42 and into the turbine 20. The flow of liquid turns the turbine 20, and the liquid exits the turbine 20 into the liquid piston tank 2 via the return check valve 43. When the liquid in the liquid piston tank 1 is partially displaced, the steam inlet valve 11 is closed, allowing the steam to expand to a lower pressure than the pressure of the steam upon exiting the solar heating tank 4. As the liquid is displaced from the liquid piston tank 1 into the liquid piston tank 2 via the check valves 42 and 43, the steam outlet valve 22 is opened to release steam from the liquid piston tank 2 into the condenser 34. The flow of liquid from the liquid piston 1 to the liquid piston 2 turns the turbine 20, which turns the generator 10 to create electrical and/or mechanical power. When the liquid piston tank 1 is empty and thus the liquid piston tank 2 is full, the steam outlet valve 22 is closed, and the steam inlet valve 12 and the steam outlet valve 21 are opened. The steam pressure is then directed from the solar heating tank 4 into the liquid piston tank 2, which similarly displaces the liquid as described with respect to the liquid piston tank 1.

In one implementation, the turbine 20 configured as a one-way turbine may increase efficiency of the liquid piston engine system by 5% to 10% resulting in increased efficiency in power production. However, the increased efficiency may be compromised by energy lost to a pressure drop from two of the four check valves 41-44 in each of the flow paths.

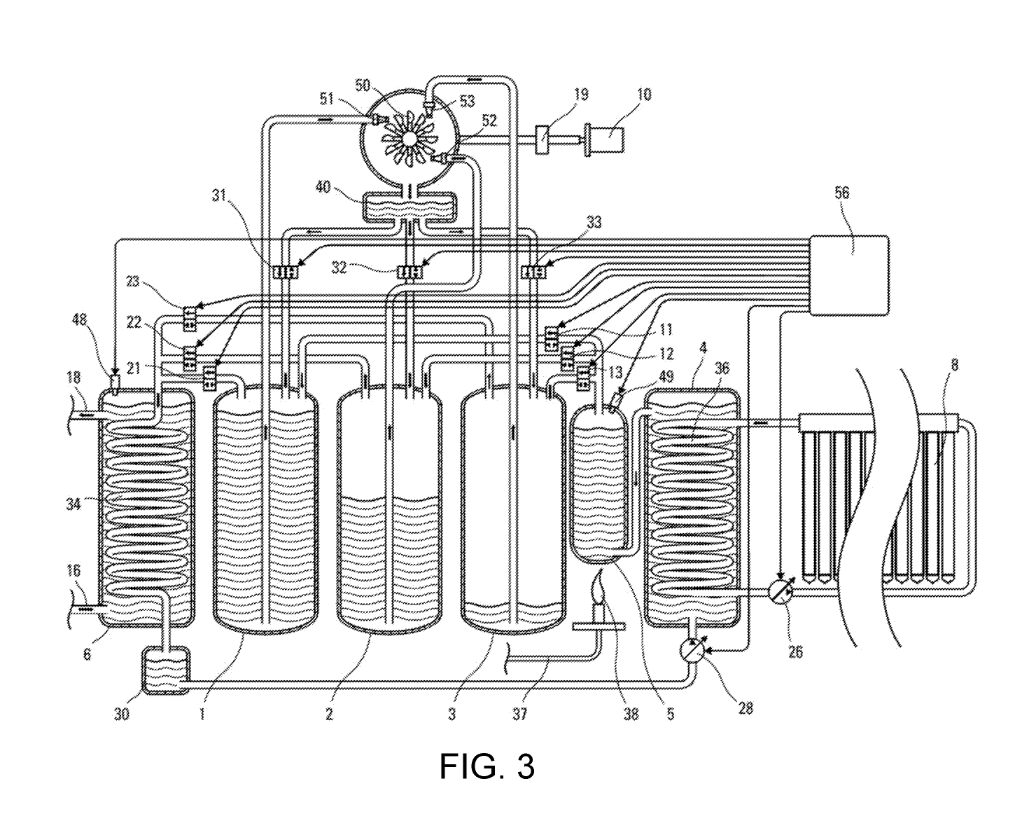

As can be understood from FIG. 3, in one implementation, the turbine 20 is replaced with an impulse turbine 50, such as a Pelton turbine, and a third liquid piston tank 3 is provided. Various other features of the liquid piston engine system illustrated in FIG. 3 may be similar to those described with respect to FIG. 1.

The impulse turbine 50 generally extracts energy from moving liquid captured in a rotary series of impulse blades disposed around a circumferential rim of a wheel or runner. In one implementation, one or more nozzles (e.g., variable flow nozzles 51-53) direct forceful, high speed streams of liquid against the impulse blades of the impulse turbine 50. As the streams of liquid impinge upon the impulse blades of the impulse turbine 50, the direction of velocity of the liquid is changed to flow the contours of the impulse blades. Liquid impulse energy exerts torque on the wheel, thereby turning the impulse turbine 50 and thus the generator 10 to create electrical and/or mechanical power. The liquid stream does a 180° turn and exits at the outer sides of the impulse blades, decelerated to a low velocity. Thus, the momentum from the liquid sprayed from the nozzles 51-53 is imparted to the impulse turbine 50.

In one implementation, the heat source includes the solar heating tank 4 and a boiler 5. As described herein, the solar panel array 8 collects solar energy, which heats a high temperature fluid. The variable flow pump 26 directs the high temperature fluid through the solar panel array 8 for heating and into the heat exchanger 36 in the solar heating tank 4, where liquid in the solar heating tank 4 is heated. Steam created by boiling the liquid is directed into the boiler 5. In one implementation, a gas line 37 provides natural gas, which may be ignited to create a flame 38 for heating liquid in the boiler 5 to create steam. The steam created with the gas line 37 and the flame 38 may supplement or replace the steam created with the solar heating tank 4. For example, where the solar panel array 8 is unable to capture sufficient solar energy to create the steam, the gas line 37 and the flame 38 may be used to create the steam.

Steam pressure held in the boiler 5 may be directed into: the liquid piston tank 1 using the steam inlet valve 11; the liquid piston tank 2 using the steam inlet valve 12; and the liquid piston tank 3 using the steam inlet valve 13. The steam inlet valves 11, 12, and 13 may each be two-way valves configured to open and close, allowing the steam pressure to flow in only one direction from the boiler 5 to the liquid piston tanks 1, 2, or 3, respectively. Similar to the steam outlet valves 21 and 22, a steam outlet valve 23 releases steam pressure from the liquid piston tank 3 and directs the steam pressure into the condenser 34. Liquid return valves 31, 32 and 33 drain liquid from the impulse turbine 50 into the liquid piston tanks 1, 2, and 3, respectively. In one implementation, liquid from the impulse turbine 50 is collected in a catch tank 40 from which the liquid is directed into the liquid piston tanks 1, 2, and 3 via the liquid return valves 31, 32, and 33, respectively. The liquid return valves 31, 32, and 33 may each be two-way valves configured to open and close, allowing the liquid to flow in only one direction from the impulse turbine 50 or the catch tank 40 to the liquid piston tanks 1, 2, or 3, respectively.

In one implementation, the impulse turbine 50 is disposed above the liquid piston tanks 1-3. To start the liquid piston engine system, steam pressure is directed into the liquid piston tanks 1-3 from the boiler 5 one at a time using the steam inlet valves 11-13. For example, the steam inlet valve 13 may be opened directing the steam pressure from the boiler 5 into the liquid piston tank 3. The pressure of the steam in the liquid piston tank 3 displaces the level of liquid downwardly within the liquid piston tank 3 and upwardly through an outlet pipe to the nozzle 53.

To optimize total system efficiency, in one implementation, the steam inlet valve 13 is open until the liquid is displaced partly down the liquid piston tank 3. When the liquid in the liquid piston tank 3 is partially displaced, the steam inlet valve 13 is closed, allowing the steam to expand to a lower pressure than the pressure of the steam upon exiting the boiler 5. In one implementation, the liquid is displaced from the liquid piston tank 3 through the outlet pipe to the nozzle 53, which sprays the liquid at the impulse blades of the impulse turbine 50, thereby generating power by turning the generator 10, as described herein. As the liquid pressure decreases in the liquid piston tank 3, the nozzle 53 may be adjusted to maintain the velocity of the liquid impacting the impulse turbine 50.

In one implementation, the liquid exits the impulse turbine 50 into the catch tank 40. As the liquid is sprayed from the nozzle 53 and collected in the catch tank 40, the steam outlet valve 21 is opened to release steam from the liquid piston tank 1 into the condenser 34, and the liquid return valve 31 is open to direct the liquid from the catch tank 40 into the liquid piston tank 1. Shortly after the steam inlet valve 13 is closed, the steam outlet valve 21 and the liquid return valve 31 are closed and the steam inlet valve 11 is opened to receive the steam pressure from the boiler 5 into the liquid piston tank 1. The liquid in the liquid piston tank 1 is similarly displaced and ultimately directed from the catch tank 40 into the liquid piston tank 2. The liquid in the liquid piston tank 2 is then similarly displaced and ultimately directed from the catch tank 40 into the liquid piston tank 3, repeating the cycle. In one implementation, there is some remaining steam pressure in the liquid piston tanks 1, 2 or 3 when one of the steam outlet valves 21, 22, or 23 is open, which keeps the liquid moving to the impulse turbine 50 while overcoming the head of liquid in a corresponding outlet pipe heading toward one of the three nozzles 51, 52, or 53.

Over time, steam from the boiler 5 condenses inside the liquid piston tank 1, 2, or 3. The condensed steam within the liquid piston tanks 1-3 does not reach the condenser 34, thereby reducing the level of liquid in the boiler 5. The excess liquid may cause at least one of the liquid piston tanks 1-3 to overflow. For example, when both the steam release valve 21, 22, or 23 and the liquid refill valve 31, 32, or 33 are open at the same time for the liquid piston tank 1, 2, or 3, there may be excess liquid causing an overflow. The excess liquid in the catch tank 40 will overflow one of the liquid piston tanks 1, 2, or 3, and the excess liquid will overflow through the corresponding steam outlet valve 21, 22, or 23 into the condenser 34. The liquid drains through the condenser 34 into the condensate tank 30 where the liquid is pumped back into the boiler 5 via the solar heating tank 4 and the variable flow pump 28.

The generator 10 will output substantially continuous power as long as there is sufficient heat input from the solar panel array 8 and/or the flame 38 to boil the liquid in the boiler 5 to a sufficient pressure. The liquid flows among the liquid piston tanks 1-3 through the nozzles 51-53 to the impulse turbine 50, thereby turning the generator 10 and generating power. In one implementation, two streams of liquid through two of the nozzles 51-53 will be impacting the impulse turbine 50 at the same time during transition between the nozzles 51-53 as the liquid empties from a corresponding liquid piston tank 1-3. During the transition, there may be a brief interruption of power output from the generator 10. Accordingly, in one implementation, the flywheel 19 is disposed along a shaft connecting the impulse turbine 50 and the generator 10 to minimize the interruption in power output. In one implementation, where the heat input declines to a level that no longer produces sufficient steam pressure in the boiler 5, some or all of the valves 11-13 and 21-23 are opened to direct the remaining steam to the condenser 34.

The generator 10 outputs different levels of power depending on a speed of the flow of displacement of the liquid in the liquid piston tanks 1-3 and thus the rate of steam created in the boiler 5. In one implementation, the rate of heat input provided to the heat exchanger 36 from the solar panel array 8 varies throughout the course of day, as the position of the sun changes from sunrise to sunset, as well as during weather events. As such, the valves 11, 12, 21, and 22 may be opened and closed depending on the rate of heat input. Moreover, the gas line 37 and the flame 38 may be used to supplement the heat input from the heat exchanger 36, and the amount of liquid flow permitted through the nozzles 51-53 may be controlled.

In one implementation, the operations of the liquid piston engine system are controlled with the controller 56. For example, the controller 56 may control the operation of the valves 11, 12, 21, 22, 26, and 28, the gas line 37, the solar panel array 8, and/or the nozzles 51-53. In one implementation, the controller 56 is in communication with one or more sensors to collect data regarding the operation of the liquid piston engine system. For example, the pressure sensors 48 and 49 may detect a pressure in the hot water heater 6 and the boiler 5, respectively, which is then communicated to the controller 56. In one implementation, the controller 56 is in communication a network for remote monitoring and management of the liquid piston engine system, as described herein.

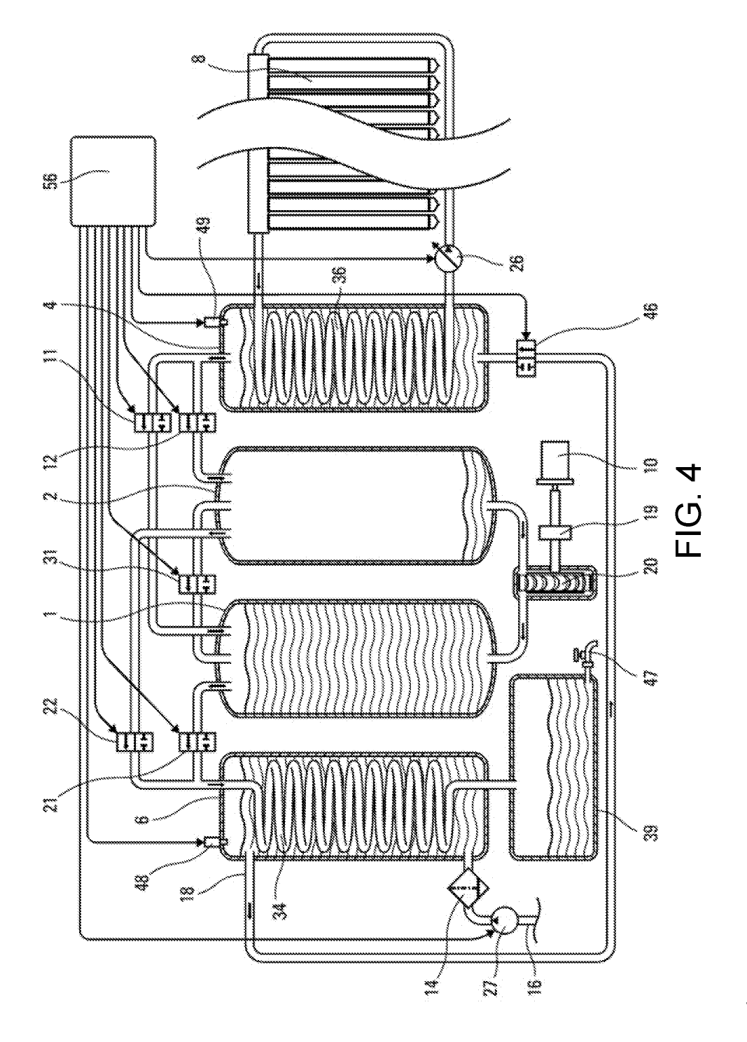

Turning to FIG. 4, the liquid piston engine system includes features similar to those described with respect to FIG. 1. In one implementation, the liquid piston engine system further includes a purified water tank 39 and a warm water tank 6.

In geographic locations with a hot climate, such as regions in Africa or other regions along the equator, household heating is generally not needed. Accordingly, in one implementation, remaining steam is condensed into drinking water using the condenser 34, as described herein, and directed into the purified water tank 39 for storage. Clean drinking water may be obtained from the purified water tank 39 via a purified water outlet 47, which may be, without limitation, a spout, nozzle, sink, or other plumbing fixture. Water for purification is directed into the condenser 34 via an inlet 16 where steam preheats the water before the water is directed to the solar heating tank 4. In one implementation, the water is heated to approximately 150° C., which is too hot for any organisms to survive. As described herein, the liquid piston engine system utilizes solar power to operate. Safe drinking water thus may be provided anywhere in the world having sufficient sun exposure.

In one implementation, dirty water enters from the inlet pipe 16, where a dirty water pump 27 pumps the dirty water to an intake pressure (e.g., approximately 5 Bars of pressure). The pressurized water is then directed through a filter 14 into the warm water tank 6. The water is heated with the steam entering the condenser 34, and the hot water exits the warm water tank 6 towards the solar heating tank 4 via an outlet pipe 18. A control valve 43 controls the flow of the hot water into the solar heating tank 4. The control valve 43 may be a two-way valve configured to open and close, allowing the hot water to flow in only one direction from the warm water tank 6 to the solar heating tank 4. The control valve 43 directs the hot water into the solar heating tank 4 to replenish the water in the solar heating tank 6 where the level of the water is low. Within the condenser 34, steam is condensed to clean liquid water, which drains into the purified water tank 39. In one implementation, the temperature of the water stored within the purified water tank 39 is cooled using, for example, a fan.

The steam inlet valves 11 and 12 are opened to direct steam and/or 150° water from the solar heating tank 4 into the liquid piston tanks 1 or 2, respectively. In one implementation, to optimize total system efficiency, the steam inlet valve 11 or 12 is open until the water is partially displaced downwardly in the liquid piston tanks 1 or 2, respectively.

Taking the liquid piston tank 1 as exemplary, the steam inlet valve 11 is open until the water is displaced partly down the liquid piston tank 1. The steam inlet valve 11 is then closed, trapping steam and/or 150° water in the liquid piston tank 1 to expand and/or evaporate as the remaining water is displaced in the liquid piston tank 1, thereby utilizing more available energy of the steam. The steam inlet valve 12 may be opened and closed similarly during displacement of the water in the liquid piston tank 2. The closer the steam is to atmospheric pressure while the turbine 20 turns, the higher the total system efficiency. In one implementation, there is some remaining steam pressure in the liquid piston tanks 1 or 2 when one of the steam outlet valves 21 or 22 is open, which keeps the water moving through the turbine 20 while overcoming the head of water building in the nearly full liquid piston tank 1 or 2.

During high efficiency operation, when the steam inlet valve 11 is opened, steam pressure is directed from the solar heating tank 4 into the liquid piston tank 1. The pressure of the steam in the liquid piston tank 1 displaces the level of water downwardly through the turbine 20 and into the liquid piston tank 2. When the water in the liquid piston tank 1 is partially displaced, the steam inlet valve 11 is closed, allowing the steam to expand to a lower pressure than the pressure of the steam upon exiting the solar heating tank 4. As the water is displaced from the liquid piston tank 1 into the liquid piston tank 2, the steam outlet valve 22 is opened to release steam from the liquid piston tank 2 into the condenser 34 within the warm water tank 6. The flow of water from the liquid piston 1 to the liquid piston 2 turns the turbine 20, which turns the generator 10 to create power to operate the components of the liquid piston engine system to produce clean drinking water. When the liquid piston tank 1 is empty and thus the liquid piston tank 2 is full, the steam outlet valve 22 is closed, and the steam inlet valve 12 and the steam outlet valve 21 are opened. The steam pressure is then directed from the solar heating tank 4 into the liquid piston tank 2, which similarly displaces the water as described with respect to the liquid piston tank 1. Each time the liquid piston engine system reverses, a valve 31 may be opened before the steam inlet valve 11 or 12 is opened to equalize the pressure between the liquid piston tanks 1 and 2. The valve 31 is then be closed prior to opening the steam inlet valve 11 or 12.

In one implementation, to prevent the 150° C. water from mixing with cold water contained within the liquid piston tanks 1 and 2, a closed cell foam bowl may be disposed on top of the cold water. The closed cell foam bowl is configured to hold the 150° C. water until it evaporates into steam. Other devices for preventing the 150° C. water from mixing with cold water are also contemplated and will be apparent to those skilled in the art.

Over time, steam from the solar heating tank 4 condenses inside the liquid piston tank 1 or 2. The condensed steam within the liquid piston tanks 1 and 2 does not reach the condenser 34, thereby reducing the level of water in the solar heating tank 4. The excess water may cause one or both of the liquid piston tanks 1 and 2 to overflow. For example, where the liquid piston tank 1 is empty and the liquid piston tank 2 is full and includes excess water, the excess water will overflow from the liquid piston tank 2 through the steam outlet valve 22 into the condenser 34, where it will drain into the purified water tank 39. Because the water from the liquid piston tanks 1 and 2 may overflow into the purified water tank 39, the water housed within the liquid piston tanks 1 and 2 is clean and devoid of parasites or other organisms that may contaminate the clean water in the purified water tank 39.

The generator 10 will output substantially continuous power as long as the solar panel array 8 is able to collect sufficient thermal energy to boil the water in the solar heat tank 4 to a sufficient pressure. The water will flow back and forth between the liquid piston tanks 1 and 2 through the turbine 20, thereby turning the generator 10 and generating power for the components of the liquid piston engine system to produce clean drinking water. In one implementation, where the thermal energy collected by the solar panel array 8 declines to a level that no longer produces sufficient steam pressure in the solar heat tank 4, some or all of the valves 11, 12, 21, and 22 are opened to direct the remaining steam to the condenser 34, where the steam is condensed into water that drains into the purified water tank 39. Because the components of the liquid piston engine system are powered by the solar panel array 8, clean drinking water is output as long as there is sufficient sun exposure.

The generator 10 outputs different levels of power depending on a speed of the flow of water through the turbine 20. The speed of the flow of water between the liquid piston tanks 1 and 2 through the turbine 20 depends on a heat input rate from the heat exchanger 36 and therefore the rate of steam creation in the solar heat tank 4. In one implementation, the rate of heat input provided to the heat exchanger 36 from the solar panel array 8 varies throughout the course of day, as the position of the sun changes from sunrise to sunset, as well as during weather events. As such, the valves 11, 12, 21, and 22 may be opened and closed, as well as other operations of the liquid piston engine system controlled, depending on the rate of heat input.

In one implementation, the operations of the liquid piston engine system are controlled with the controller 56, which is powered using the power output by the generator 10. For example, the controller 56 may control the operation of the valves 11, 12, 21, 22, 26, and 28. In one implementation, the controller 56 is in communication with one or more sensors to collect data regarding the operation of the liquid piston engine system. For example, pressure sensors 48 and 49 may detect a pressure in the warm water tank 6 and the solar heating tank 4, respectively, which is then communicated to the controller 56. In one implementation, the controller 56 is in communication a network for remote monitoring and management of the liquid piston engine system, as described herein.

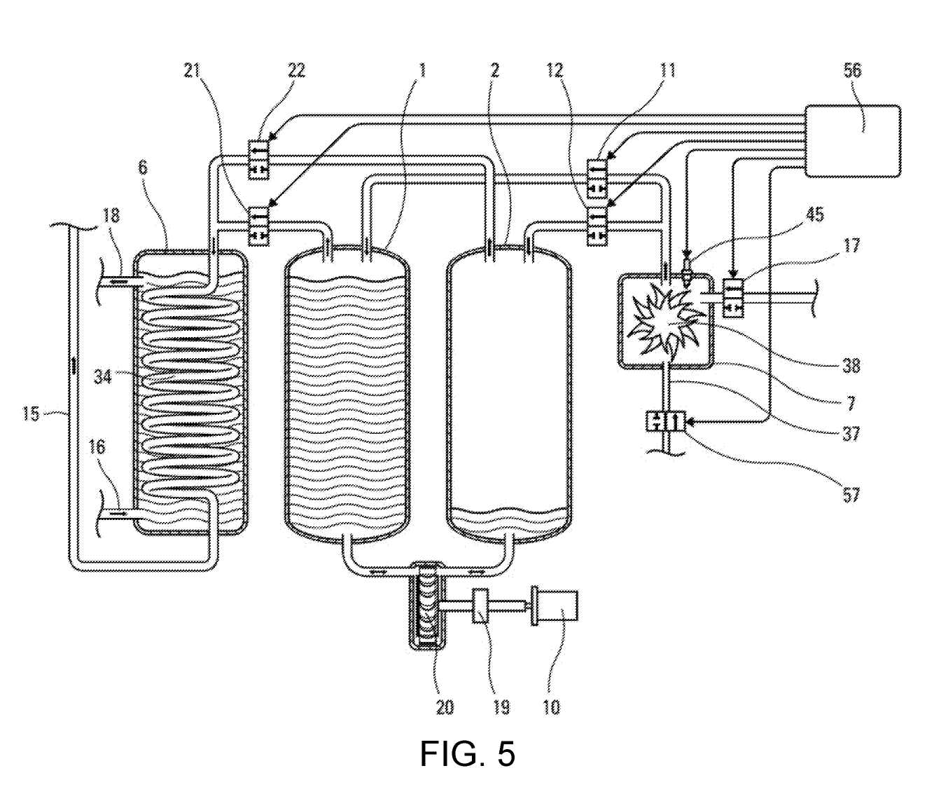

Referring to FIG. 5, in one implementation, pressure to drive the liquid piston tanks 1 and 2 is created using a combustion chamber 7. A combustible gas or other fuel is fed into the combustion chamber 7 via a gas line 37 in a controlled manner using a gas valve 57. Pressurized air is admitted into the combustion chamber 7 via an air valve 17. A spark plug 45 ignites to initiate combustion within the combustion chamber 7, thereby creating pressurized gas.

The inlet valve 12 is opened, directing the combustion pressure from the combustion chamber 7 into the liquid piston tank 2. The pressurized gas in the liquid piston tank 2 displaces the level of liquid downwardly through the turbine 20 and into the liquid piston tank 1. As the liquid is displaced from the liquid piston tank 2 into the liquid piston tank 1, the outlet valve 21 is opened to release exhaust from the liquid piston tank 1 into the condenser 34, which is output via an exhaust pipe 15. The flow of liquid from the liquid piston 2 to the liquid piston 1 turns the turbine 20, which turns the generator 10 to create electrical and/or mechanical power.

When the liquid piston tank 2 is empty and thus the liquid piston tank 1 is full, the inlet valve 12 and the outlet valve 21 are closed. At that time, the gas valve 57 and the air valve 17 are opened until a proper mixture ratio of pressurized air and combustible gas is obtained for combustion within the combustion chamber 7. The spark plug 45 then ignites to create combustion pressure, which is directed toward the liquid piston tank 1. The inlet valve 11 and the outlet valve 22 then are opened, thereby reversing the flow of liquid. When the flow of liquid reverses, there may be a brief interruption of power output from the generator 10. Accordingly, in one implementation, the flywheel 19 is disposed along a shaft connecting the turbine 20 and the generator 10 to minimize the interruption in power output. Alternatively or additionally, the turbine 20 may include a relatively heavy wheel to reduce the interruption on power output.

The liquid flows back and forth between the liquid piston tank 1 and the liquid piston tank 2, creating a closed loop two tank system. The turbine 20 flows in the same direction independent of which way the liquid is flowing between the liquid piston tanks 1 and 2. As such, the turbine 20 continues to turn the generator 10, thereby creating substantially continuous power with any interruptions in power output minimized by the flywheel 19, for example.

The liquid piston engine system generates different levels of power using the generator 10 depending on the speed of the flow of liquid through the turbine 20. The speed of the flow of liquid between the liquid piston tank 1 and the liquid piston tank 2 through the turbine 20 depends on the rate of heat input and thus the rate and intensity of combustion in the combustion chamber 7. Thus, variations in power output may be controlled based on an amount of air and combustible gas admitted via the valves 17 and 57, respectively. Increasing the combustion pressure delivered to the liquid piston tanks 1 or 2, increases the speed of the flow of liquid through the turbine 20, thereby increasing the power output by the generator 10.

In some implementations, given that the mass of liquid displaced from one of the liquid piston tanks (e.g., the liquid piston tank 1, 2, or 3) is equal to the mass of liquid directed into the impulse turbine 50 or directly into another liquid piston tank, the liquid piston engine system experiences substantially no vibration. Moreover, any vibration created is damped by the liquid housed within the liquid piston engine system. The lack of vibration permits the liquid piston engine system to be mounted in various locations, such as a rooftop.

For a detailed discussion of the use of the solar panel array 8 as the heat source, reference is made to FIGS. 1-4. In one implementation, a rate of the flow of the high temperature fluid through the solar panel array 8 is varied throughout the day using the variable flow pump 26 to achieve a consistent output temperature of approximately 180° C. In another implementation, panels in the solar panel array 8 are connected in a series configuration during weaker solar exposure times (e.g., early morning and late afternoon) and are moved to a parallel arrangement during peak solar exposure times (e.g., noontime to early afternoon). Switching the panels in the solar panel array 8 from a series configuration to a parallel configuration during peak solar exposure times ensures that the panels do not overheat.

The vapor pressure of water (i.e., the boiling point of water) is approximately 4.5 Bar (i.e., 4.5. times atmospheric pressure) at 150° C. Holding the pressure in the solar heating tank 4 to that level will cool the high temperature fluid from the solar panel array 8 to that temperature. As heat builds in the morning from the solar panel array 8, steam is generated faster, thereby driving the liquid pistons faster and increasing the power output by the generator 10. With respect to the example configuration shown in FIG. 3, the pressure above the liquid piston tanks 1-3 is controlled by the nozzles 51-53. Thus, as heat builds in the morning, the nozzles 51-53 may be opened more throughout the morning and closed as sun exposure decreases. In other words, the rate at which the solar energy is converted to power is controlled by the degree to which the nozzles 51-53 are open. With respect to simpler configurations, such as those illustrated in FIGS. 1, 2, and 4, the steam pressure varies throughout the day based on limitations of the turbine 20.

In one implementation, the solar panel array 8 includes four 13 kW per day panels deployed in a series configuration, which move to a parallel configuration with three four-way valves as the heat rate increases and vice versa. Based on 40% of that total energy being available to the generator 10, the generator 10 may be a 3 hp asynchronous AC motor or similar motor or device. Subtracting electrical losses for 2 pump and a camshaft drive motor, the liquid piston engine system may produce at least 20% electrical efficiency, which would equate to an electrical energy production of approximately 11 kW hours per day on a sunny day.

In one implementation, to convert the 4.5 atmospheres of steam energy into hydropower, a boiling tank (e.g., the solar heating tank 4, the boiler 5, and/or the combustion chamber 7) and a plurality of the liquid piston tanks (e.g., two to four tanks) are provided to create a flow of liquid to the turbine 20 or the impulse turbine 50. The steam pressure from the boiling tank is switched from one of the liquid piston tanks to the next when the previous tank is empty. In this way, the solar heated steam is switched between the liquid piston tanks and the liquid in each of the liquid piston tanks is displaced to the turbine 20 or the impulse turbine 50. With respect to the impulse turbine 50, once one of the liquid piston tanks is empty, it is refilled by gravity with liquid exiting the impulse turbine 50. With respect to the turbine 20, the liquid piston tanks are refilled by force of steam pressure. The residual steam in each of the liquid piston tanks is pushed into the condenser 34, where the liquid condensed from the steam may be directed back into the boiling tank and/or into the purified water tank 39.

In one implementation, the liquid piston engine system may include a DC pumping system for use where the power grid is down. The DC pump may be used in the morning to start the variable flow pump 28 providing the high temperature fluid into the solar panel array 8. In one implementation, the solar panel array 8 may include high temperature evacuated tube type solar collectors, which may be prone to breaking as a result of overheating during high sun exposure. Therefore, a parallel variable speed DC pump may be used in parallel with a fixed speed AC pump to transfer heat away from the solar collectors, even when the power grid is down. Once the boiling tank is to pressure, the steam will flow to one of the liquid piston tanks, thereby turning an AC motor to charge batteries, for example. Where the liquid piston engine system is deployed at an off-grid or unstable grid location, a DC system or a DC system with an inverter may be used.

To efficiently build the liquid piston engine system in high volume, in one implementation, an aluminum cylinder head is used above the liquid piston tanks plus a boiling tank (e.g., the solar heating tank 4, the boiler 5, and/or the combustion chamber 7). The impulse turbine 50 may be mounted on top of the cylinder head to facilitate draining back into the liquid piston tanks. Attached to or within the cylinder head, all or most of the plumbing may be deployed, including, without limitation, all the tanks except for the home hot water heater 6, the water flow passages to the turbine nozzles 51-53, the heat exchanger 36, the condenser 34, all the valves, and all the pumps.

In one implementation, the liquid piston engine may be built in behind the solar tubes in the solar panel array 8. A main panel may be part of an eight feet by eight feet frame with the liquid piston engine built inside, and two half panel wings may fold out to make an eight feet high by sixteen feet wide solar panel array. It will be appreciated that other sizes of the solar array panel 8 are contemplated.

All or some of the panels, such as the half panel wings, of the solar panel array 8 may be motorized and configured to close based on input, which may be received automatically using sensor data and/or information received over a network, as detailed herein. For example, weather reports or detected weather conditions may trigger the solar panel array 8 to close. Additionally, a direction of direct sun exposure may be detected or otherwise determined, and the solar panel array 8 may move to an orientation or direction to optimize sun exposure.

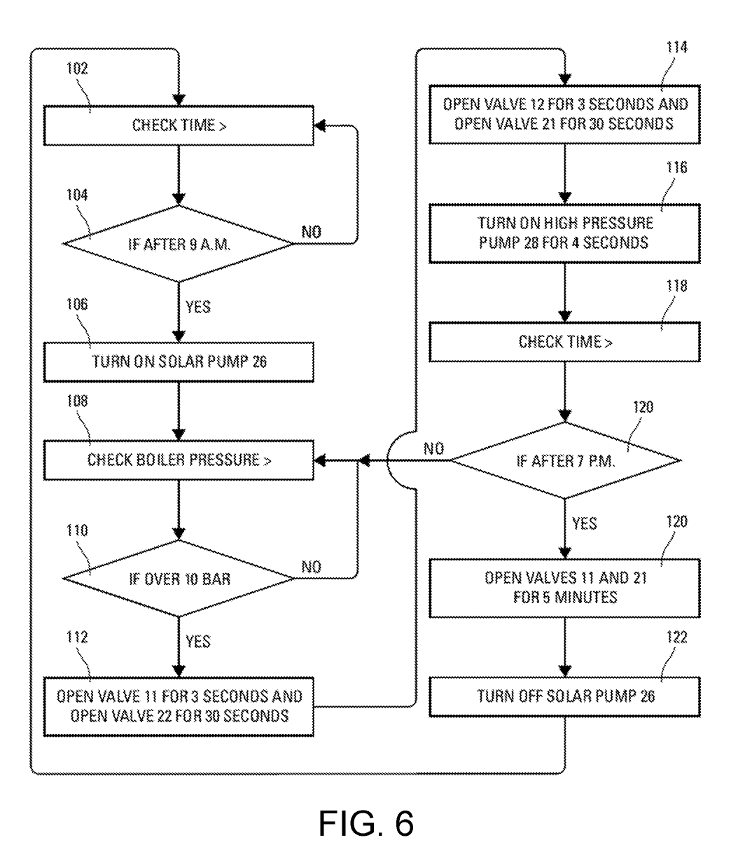

FIG. 6 illustrates example operations for generating substantially continuous power. The operations may be used for example, to control the liquid piston engine system of FIG. 1 or 2. As detailed herein, the operations of the liquid piston engine system may be controlled by the controller 56. In one implementation, an operation 102 determines whether to initiate the liquid piston engine system. For example, the operation 102 may check a current time of day, and an operation 104 determines whether the current time of day is after a time threshold, which may be, 9:00 AM. If the operation 104 determines that the time threshold is met, an operation 106 initiates a heat source, and if the operation 104 determines that the time threshold is not met, the operation 102 is repeated. The operation 102 may also initiate the liquid piston engine based on user input, a weather report, sunrise time, and/or the like.

In one implementation, the operation 106 includes turning a solar pump on where the heat source includes a solar panel array configured to create solar energy. However, the operation 106 may vary depending on the nature of the heat source. In one implementation, following the initiation of the heat source with the operation 106, an operation 108 checks a pressure in a boiling tank, which may be a solar heating tank, a boiler, and/or a combustion chamber, and an operation 110 determines whether sufficient pressure (e.g., steam or combustion pressure) is present. For example, sufficient pressure may be present where the pressure exceeds a pressure threshold, which may be 10 Bar.

If the operation 110 determines that the pressure threshold is met, an operation 112 opens a first inlet valve from the boiling tank to a first liquid piston tank and a first release valve from the first liquid piston tank to a condenser, and if the operation 110 determines that the pressure threshold is not met, the operation 108 is repeated. The operation 112 may open the first inlet valve and the first release valve for various lengths of time depending on a rate of displacement of liquid in the first liquid piston tank. For example, the first inlet valve may be open for three seconds before closing and the first release valve may be open for thirty seconds before closing.

After the lengths of time have elapsed corresponding to a substantially complete displacement of the liquid in the liquid piston tank, an operation 114 opens a second inlet valve from the boiling tank to a second liquid piston tank and a second release valve from the second liquid piston tank to the condenser. The operation 114 may open the second inlet valve and the second release valve for various lengths of time depending on a rate of displacement of liquid in the second liquid piston tank. For example, the second inlet valve may be open for three seconds before closing and the second release valve may be open for thirty seconds before closing. The operations 112-114 may be repeated for each liquid piston tank included in the liquid piston engine system.

In one implementation, an operation 116 refills the boiling tank using a variable flow pump. The operation 116 may refill the boiling tank based on a level of liquid in the boiling tank and/or following the operation 114 for a predetermined length of time, such as thirty seconds. An operation 118 determines whether to shut down the liquid piston engine system. For example, the operation 118 may check a current time of day, and an operation 120 determines whether the current time of day is after a time threshold, which may be, 7:00 PM. If the operation 120 determines that the time threshold is met, an operation 120 opens all the valves to release any remaining steam into the condenser, and if the operation 120 determines that the time threshold is not met, the operations 108-118 are repeated. The operation 120 may open all the valves based on an amount of remaining steam or for a predetermined time, such as five minutes. In one implementation, following the operation 120, an operation 122 turns of the heat source, such as the solar pump, and process returns to the operation 102.

It will be appreciated by those skilled in the art that the times, pressures, and the like depicted in FIG. 6 are exemplary only and not intended to be limiting. For example, the amount of time to empty a liquid piston tank can change radically as a function of a change in pressure or a change in the size of the liquid piston tank. In some cases, the times will be replaced by an array of numbers that vary as a function pressure. Similarly, the time of day may be an array of numbers that change throughout the year or as a function of distance north or south of the equator where the liquid piston engine system is installed. These values may further change as a function of input from another program such as a weather application or other data source that provides the data on the time of day for sunrise and sunset. The weather application could also provide input on how much sun will be available to the system on a given day, so that energy could be saved from having to run the solar pump on day where there will not be enough sunshine for the system to reach operating pressures.

As described herein, the controller 56 controls the various operations of the liquid piston engine system. Power may be supplied to the controller 56 from the generator 10. In one implementation, the controller 56 controls the operation of the various components automatically or manually based on input received on-site or remotely. The input may include, without limitation, user input, information from various data sources (remote or on-site), information provided by one or more sensors detecting operational parameters of the liquid piston engine system, and/or the like.

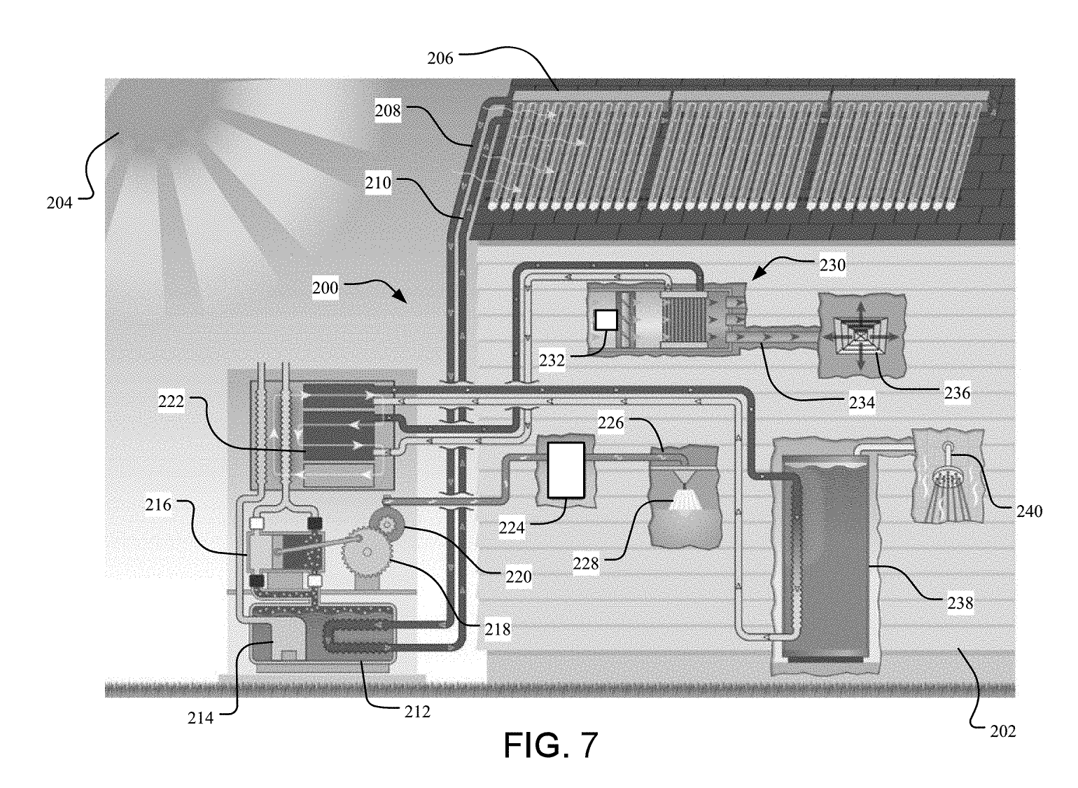

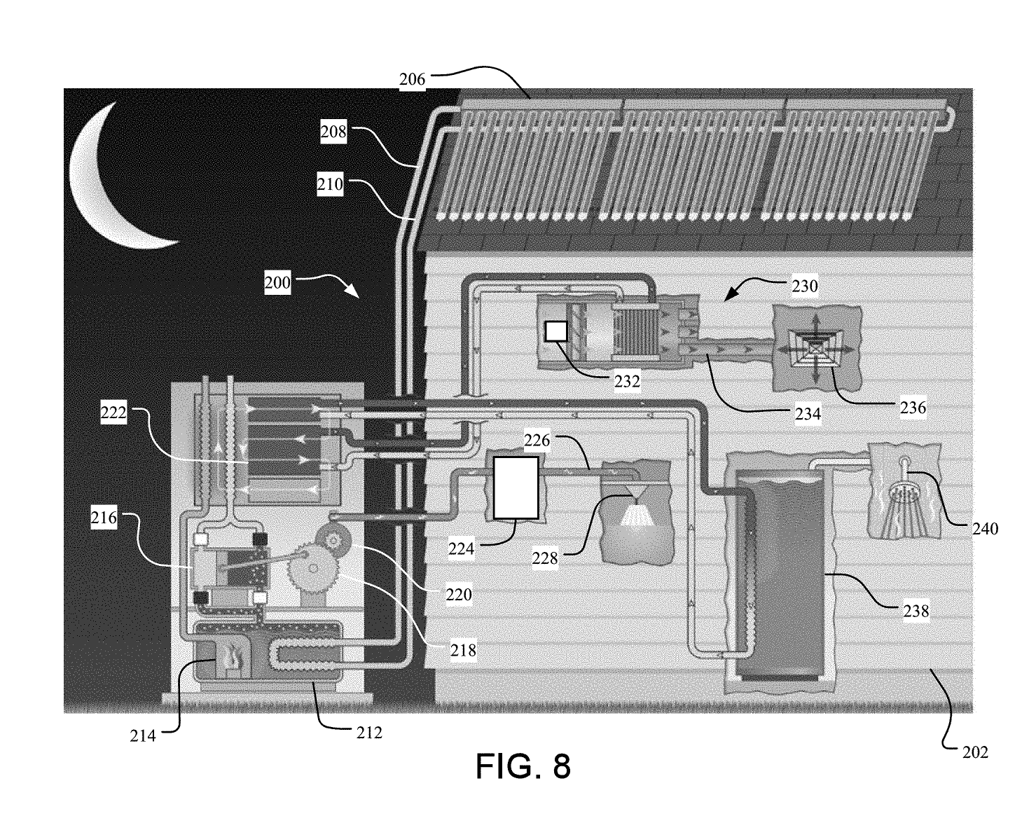

Turning to FIGS. 7-8, an example hybrid energy system 200 for providing energy to a defined space, such as building 202, is shown. The hybrid energy system 200 may incorporate or otherwise include various features and/or functionality of the liquid piston engine systems discussed herein. As can be understood from FIGS. 7-8, the hybrid energy system 200 provides one or more energy inputs into the building 202 in the presence and absence of sunlight 204.

In one implementation, the hybrid energy system 200 includes a solar panel array 206 including one or more solar panels. The solar panel array 206 is connected to a solar boiler 212 via a solar output 208 and a solar input 210. The hybrid energy system 200 further includes a combustion boiler 214 and a steam engine 216 connected to one or more gears 218 and a generator 220. The generator 220 is in communication with an inverter 224, providing electrical energy to one or more electrical systems 228 in the building 202 via electrical wiring 226. The steam engine 216 and/or the combustion boiler 214, along with a chiller 222, provide heating venting and cooling to the building 202 via a heat exchanger 230. The heat exchanger 230 may utilize one or more fans 232, ducts 234, vents 236, and/or the like. The steam engine 216, the combustion boiler 214, and/or the chiller 222 may be further connected to a water heater tank 238 via piping to provide water or other fluid to one or more fluid dispensing systems 240.

Generally, as shown in FIGS. 7-8, heat from the sunlight 204 is absorbed by the thermal solar panels 206. This thermal energy is transferred to the solar boiler 212, which creates steam. The steam pressure is used to drive the pistons of the steam engine 216. The steam engine 216 turns the generator 220, for example, using the gears 218, to make electricity for the building 202. Waste heat from the steam engine 216 is sent into the absorption chiller 222 to create air-conditioning. This removes the electricity load of a traditional air conditioner. In the winter, this process can be reversed, throwing away the cold and creating heating for the building 202. Finally, waste heat from the chiller 222 is sent to the water heater tank 238, creating a supply of hot water for the next 24 hours or other predefined duration.

If the system 200 needs to run when there is little or no sunlight 204 it can use natural gas via the combustion boiler 214 to supplement or replace the solar thermal energy generated by the solar boiler 212. With a possible 24 hour or other predefined up time, the presently disclosed technology is the complete energy system solution to satisfy air conditioning, heat, hot water, and electricity needs for a building 202.

The piston steam engine 216 in combination with the absorption chiller 222 provides a plurality of disparate energy inputs to the building 202, with the solar panel array 206 providing some or all of the heat input via the solar boiler 212. The solar thermal heat input generated by the solar boiler 212 can be supplemented with combustion energy generated by the combustion boiler 214 from natural gas or propane or a type of pellet stove that can burn pellets, wood chips, garbage, card board, and/or dry farm waste. The combustion boiler 214 may supplement the solar boiler 212 by feeding any burnable material or fuel to a firebox that can change the rate of delivery of air and fuel to accommodate a heating value of the fuel and maintain a proper air-to-fuel ratio of the fuel in order to achieve a desired level of heat output. The hybrid energy system 200 provides electricity, heat, hot water, and air conditioning for the building 202. It will be appreciated that the hybrid energy system 200 can run solely on solar heat, solely on combustion energy, or a combination of both, thereby enabling the hybrid energy system 200 to run in bad weather or run at night or run at a desired power level even when there isn't enough of the sunlight 204 to produce sufficient solar energy at that time.

In addition to providing cooled liquid to the fluid dispensing systems 240, the cooling liquid output of the chiller 222 may be used to cool a larger refrigerator for food storage, for example, at a remote location that has no electric power. The water of the steam engine 216 can be closed or open. In a closed system, the water is condensed and put back into the boiler 212 and/or water tank heater 238 at approximately 90 degrees Celsius. This improves efficiency over having to heat cold water in the boiler 212 and/or water tank heater 238 and reduces water consumption. In an open system the steam condensed to water is cooled by the incoming water and is now free of parasites, bacteria and viruses. The water may be treated or supplemented with various minerals for drinking.

In one implementation, the hybrid energy system 200 includes the steam engine 216 with a two-stage boiler allowing a plurality of different energy inputs at a plurality of different temperatures. The first stage of heat is generated by the solar boiler 212 from solar thermal energy captured via the solar panel array 206, and the second stage is generated by the combustion boiler 214 from combustion energy. The second stage may alternatively or additionally involve other forms of higher temperature heat when the energy generated from the solar boiler 212 alone is insufficient to power the steam engine 216 at a desired power level. In one example, 20 to 200 psi steam is generated first from solar energy and second from combustion energy if the solar energy is insufficient to achieve a high enough pressure or temperature. For example, 150 psi steam in a desired level of pressure may be needed to generate a rated power of the steam engine 216.

In one implementation, boiling is performed in a single two-stage boiler or in heat exchangers disposed one above the other (e.g., a solar exchanger disposed lower relative to a combustion exchanger). In either implementation, the two-stage boiler involves the solar boiler 212 and the combustion boiler 214 or the equivalents for generating solar energy and supplemental energy. The solar boiler 212 may be lower temperature than what is needed for boiling water to an ideal temperature and pressure. If the correct temperature is not achieved using the solar boiler 212 alone, the combustion boiler 214 is initiated to provide the added energy needed to reach the proper operating temperature and pressure for the hybrid energy system 200 to work at the target power level.

Referring to the chiller 222, in one implementation, the chiller 222 has an evaporator to boil refrigerant. The evaporator receives its heat from the steam exiting the steam engine 216, which condenses the steam. The heat exchanger 230 is the evaporator for the chiller and the condenser for the steam engine 216, receiving the heat output with the waste steam exiting the steam engine 216.

In one implementation, a ground based heat exchanger may be used to shed unneeded waste heat and/or unneeded cold from the chiller 222 in the winter, thereby improving efficiency of the hybrid energy system 200. For example, given the ground below the frost line is approximately ten degrees Celsius on average in many climates, an in-ground heat exchanger can work year-round. Ground sinking the cold from the chiller 222 amplifies the heat output coming from the hybrid energy system 200 into the building 202 in the winter. This makes efficiency of heat generation greater in the wintertime when the amount of solar energy from sunlight 204 is lower from shorter days.

In one implementation, the solar panel array 206 is sized to ensure that the output is a high enough temperature to run the steam engine 216 and the chiller 222 without using any back up energy, for example via the combustion boiler 214, for at least two hours or other predefined duration in the middle of a sunny day. If the solar panel array 206 is larger, it may result in a waste of roof or other area space for the budding 202 and add unnecessary cost. If the solar panel array 206 is smaller, additional back-up energy may be needed more of the time and therefore reduce the payback time for the hybrid energy system 200. Variations in the climate associated with the building 202 may result in a larger panel for reducing combustion energy.

Generally, solar heat captured via the solar panel array 206 generates heat from the sunlight 204, which is converted into boiling water with the solar boiler 212. The boiling water runs the steam engine 216. If there is not enough solar energy to run the steam engine 216, the combustion boiler 214 is initiated to heat the water to the boiling pressure needed for running the steam engine 216. The steam engine 216 can make anywhere from a hundred watts up to ten kilowatts depending on the size of the steam engine 216 and the number of cylinders.

The waste heat in the form of low temperature steam from the exhaust of the pistons of the steam engine 216 is output into the chiller 222, which utilizes the heat to generate cool air and/or fluid. The chiller 222 may be an absorption chiller or other forms of chillers. By using the waste heat for air-conditioning, refrigeration, and/or the like, the need for electrically powered air conditioning for the building 202 is eliminated. The chiller 222 can also be used in reverse in the winter time in conjunction with a ground sink for the cold energy. This will allow the hybrid energy system 200 to generate extra heat in the winter by absorbing some heat energy from the ground. In the summertime, ground sink may be used to promote the absorber while the condenser is used to add heat to the hot water system 238.

In one implementation, the solar boiler 212, alone or in combination with the combustion boiler 214, generates steam at approximately 180 degrees Celsius, which the steam engine 216 generates electricity from 150 psi. The waste steam is output from the steam engine 216 into the chiller 222 at approximately 110 degrees Celsius for air conditioning via the heat exchanger 230. The waste heat from the chiller 222 is output to the water heater tank 238 at approximately 60 degrees Celsius. The hybrid energy system 200 provides solar cogeneration, which utilizes multiple stages of heat to generate multiple types of energy at the one to ten kilowatt scale. The hybrid energy system 200 provides solar cogeneration via a piston engine and back-up energy supplementation for use in the absence or decreased level of sunlight 204. The piston engine utilizes lower temperature and lower pressure wet steam, increasing efficiency and safety.

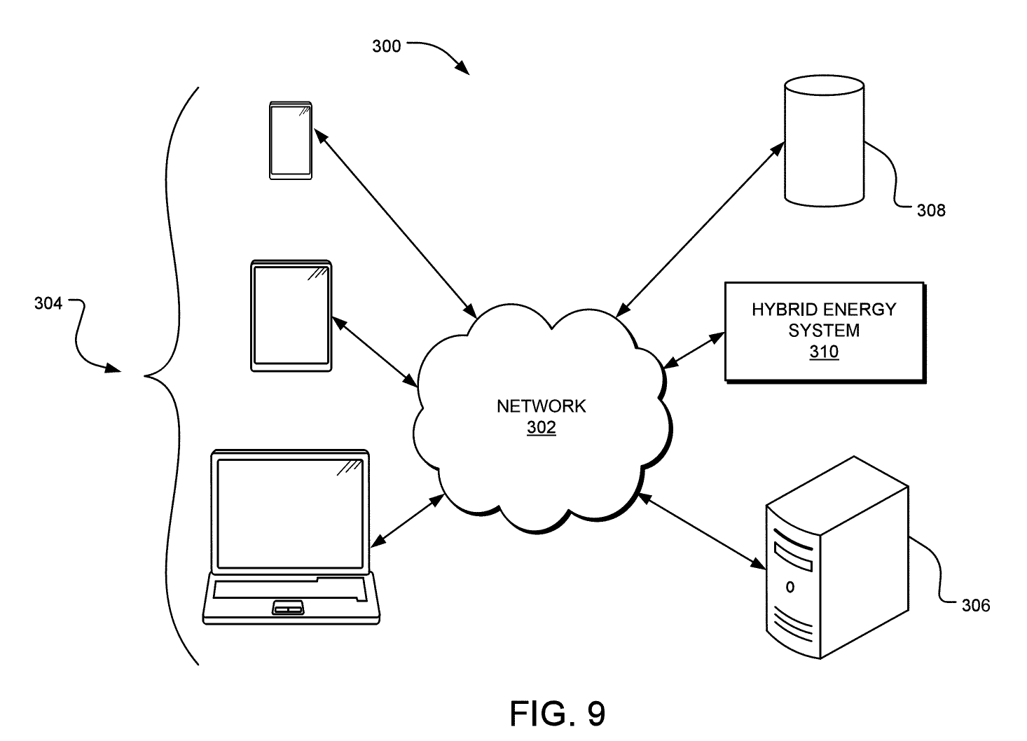

FIG. 9 illustrates an example network environment 300 for remotely monitoring, managing, and/or controlling one or more hybrid energy systems 310, which may include one or more of the various liquid piston engine systems, hybrid energy systems, and/or the like, over a network 302 (e.g., the Internet). As depicted in FIG. 9, the network 302 is used by one or more computing devices and/or data storage devices (e.g., one or more databases 308). In one implementation, the hybrid energy systems 310 and one or more user devices 304 are communicatively connected to the network 302. Examples of the user devices 304 include, without limitation, a personal computer, a workstation, a terminal, a lap top, a smartphone, a tablet, a multimedia console, a set top box, and the like. A user may access the system 300 using the user devices 304. Users may include, for example, an owner and user of one or more hybrid energy systems 310, at the same or different locations; an administrator of a utility service providing power and/or purified water that monitors and manages one or more hybrid energy systems 310 for one or more clients; and clients of such utility services.

A server 306 hosts the system 300. In one implementation, the server 306 also hosts a website or an application that users visit to access the system 300. The server 306 may be one single server, a plurality of servers with each such server being a physical server or a virtual machine, or a collection of both physical servers and virtual machines. In another implementation, a cloud hosts one or more components of the system 300. The hybrid systems 310, the user devices 304, the server 306, the databases 308, and other resources connected to the network 202 may access one or more other servers for access to one or more websites, applications, web services interfaces, etc. that are used to remotely monitor and manage the hybrid energy systems 310. For example, sources of data providing information on weather conditions, sun exposure (e.g., sunrise and sunset times), and the like may be retrieved via the network 302 from a variety of resources. In one implementation, the server 306 also hosts a search engine that the system 300 uses for accessing and modifying information used to remotely monitor and manage the hybrid energy systems 310.

In one implementation, each of the hybrid energy systems 310 includes one or more sensors, which receive data relating to weather conditions, solar energy conditions, operational parameters of the hybrid energy systems 310, and any other factors that may impact power output. For example, the sensors may include, without limitation, a solar sensor, a wind speed and direction sensor, a humidity sensor, a barometric pressure sensor, a temperature sensor, and/or other sensors for measuring and determining weather conditions. The sensors may further include, without limitation, a load sensor for measuring the output of the generator, pressure sensors (e.g., sensors 48 and 49), a thermal sensor, an RBG sensor, and/or other operational sensors. The operational sensors receive data relating to the operation of the hybrid energy systems 310, which may indicate, for example: when to cover or otherwise protect the solar panel array; operate one or more valves, pumps, and/or nozzles; whether maintenance is needed; whether the move the solar panel array to a different orientation or direction based on sun exposure; and a status of power output and/or water purification.

In one implementation, the application running on the server 306 and/or the sensors deployed with the hybrid energy systems 310, receive and analyze the data, as described herein, and based on the data, automatically issue a command to control the operation of the hybrid energy systems 310. In another implementation, a user receives the raw data and/or an analysis of the data via the network 302 on the user devices 304. The user may view the data or send a command from the user devices 304 via the network 302, for example, to: turn the hybrid energy systems 310 on or off; move or cover the solar panel array; change the operational parameters of the hybrid energy systems 310; determine whether and what type of maintenance is necessary for the hybrid energy systems 310; to determine a status of power output and/or water purification; and/or perform other analysis or functions.

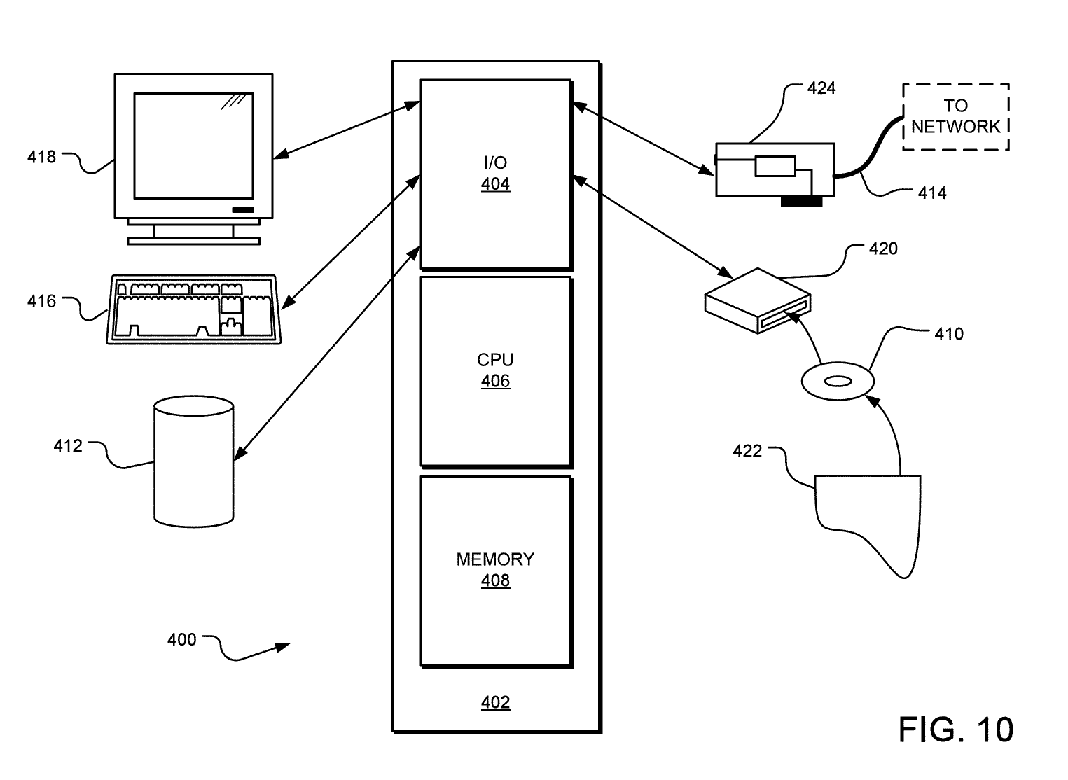

Referring to FIG. 10, a detailed description of an example computing system 400 having one or more computing units that may implement various systems and methods discussed herein is provided. The computing system 400 may be applicable to the user devices, servers, controller, and other computing or network devices. It will be appreciated that specific implementations of these devices may be of differing possible specific computing architectures not all of which are specifically discussed herein but will be understood by those of ordinary skill in the art.

The computer system 400 may be a general computing system is capable of executing a computer program product to execute a computer process. Data and program files may be input to the computer system 400, which reads the files and executes the programs therein. Some of the elements of a general purpose computer system 400 are shown in FIG. 4 wherein a processor 402 is shown having an input/output (I/O) section 404, a Central Processing Unit (CPU) 406, and a memory section 408. There may be one or more processors 402, such that the processor 402 of the computer system 400 comprises a single central-processing unit 406, or a plurality of processing units, commonly referred to as a parallel processing environment. The computer system 400 may be a conventional computer, a distributed computer, or any other type of computer, such as one or more external computers made available via a cloud computing architecture. The presently described technology is optionally implemented in software devices loaded in memory 408, stored on a configured remote storage medium 410 or storage unit 412, and/or communicated via a wired or wireless network link 414, thereby transforming the computer system 400 in FIG. 10 to a special purpose machine for implementing the described operations.

The I/O section 404 is connected to one or more user-interface devices (e.g., a keyboard 416 and a display unit 418), a disc storage unit 412, and a disc drive unit 420. In the case of a tablet device or smartphone, the input may be through a touch screen, voice commands, and/or Bluetooth connected keyboard, among other input mechanisms. Generally, the disc drive unit 420 is a DVD/CD-ROM drive unit capable of reading the remote storage medium 410, which typically contains programs and data 422. Computer program products containing mechanisms to effectuate the systems and methods in accordance with the presently described technology may reside in the memory section 404, on a disc storage unit 412, on the remote storage medium 410 of the computer system 400, or on external storage devices made available via a cloud computing architecture with such computer program products, including one or more database management products, web server products, application server products, and/or other additional software components. Alternatively, a disc drive unit 420 may be replaced or supplemented by an optical drive unit, a flash drive unit, magnetic drive unit, or other storage medium drive unit. Similarly, the disc drive unit 420 may be replaced or supplemented with random access memory (RAM), magnetic memory, optical memory, and/or various other possible forms of semiconductor based memories commonly found in smartphones and tablets.

The network adapter 424 is capable of connecting the computer system 400 to a network via the network link 414, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as terminals, workstations, mobile phones, tablets, laptops, personal computers, multimedia consoles, gaming consoles, set top boxes, and the like.

When used in a LAN-networking environment, the computer system 400 is connected (by wired connection or wirelessly) to a local network through the network interface or adapter 424, which is one type of communications device. When used in a WAN-networking environment, the computer system 400 typically includes a modem, a network adapter, or any other type of communications device for establishing communications over the wide area network. In a networked environment, program modules depicted relative to the computer system 400 or portions thereof, may be stored in a remote memory storage device. It is appreciated that the network connections shown are examples of communications devices for and other means of establishing a communications link between the computers may be used.

In an example implementation, remote monitoring and management software, hybrid energy system controller software, and other modules and services may be embodied by instructions stored on such storage systems and executed by the processor 402. Some or all of the operations described herein may be performed by the processor 402. Further, local computing systems, remote data sources and/or services, and other associated logic represent firmware, hardware, and/or software configured to control operations of the controller 56, the various servers, user devices, network components, and/or computing units. Such services may be implemented using a general purpose computer and specialized software (such as a server executing service software), a special purpose computing system and specialized software (such as a mobile device or network appliance executing service software), or other computing configurations. In addition, one or more functionalities of the systems and methods disclosed herein may be generated by the processor 402 and a user may interact with a Graphical User Interface (GUI) using one or more user-interface devices (e.g., the keyboard 416 and the display unit 418) with some of the data in use directly coming from online sources and data stores.

The system set forth in FIG. 10 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The various advantages of the presently disclosed technology will be apparent from the above descriptions. Further to emphasize the value and efficiency of the liquid piston engine system, the following data and calculations are provided with reference to the configuration of FIG. 3. The data and calculations are exemplary only not intended to be limiting.

Boiler Feed Water and Steam Cycle:

In the special case shown below, the feed water pump compresses the same mass as the needed steam mass. Here the pressure is raised from 0.29 to 14 bar and then the feed-water respectively the wet steam has to be warmed up from 333.15 to 468.22 K.

After the steam expanded to 1.7 bar, blow down expelling takes place and then the wet steam has to be condensed and cooled down back to (feed-) water with 333.15 K and 0.29 bar. The boiler feed water mass and therefore the steam mass in this special case is 235.438 g.

Specific conditions in front of pump:

| P | T | V | X | H | U | s |
|---|---|---|---|---|---|---|
| N/m\hat{ }2 | K | m\hat{ }3/kg | — | J/kg | J/kg | J/kg K |
| 29000.0 | 333.15 | 0.10171E−02 | −2.000 | 251155.4 | 251125.9 | 831.16 |

Feed water pump:

| yPu | DhPu | aPump | EtaP |
|---|---|---|---|
| J/kg | J/kg | J/kg | % |
| 1394.174 | 2323.623 | 2323.623 | 60.000 |

Feed water receives specific pumping work 253,479.0−251,155.4=2,323.6 J/kg to raise the pressure from 0.29 bar to 14.0 bar.

Specific conditions at feed-water pump exit:

| P | T | V | X | H | U | s |
|---|---|---|---|---|---|---|
| N/m\hat{ }2 | K | m\hat{ }3/kg | — | J/kg | J/kg | J/kg K |
| 1400000.0 | 333.43 | 0.10167E−02 | −2.000 | 253479.0 | 252055.7 | 833.95 |

Feed water is getting specific heat of 830,331.6−253,479.0=576,852.6 J/kg to increase the temperature from 333.43 K to 468.22 K (boiling point for 14 bar).

At this point heat with less temperature (here less than 468.22 K—possibly from other sources) can be coupled in (e. g. solar heat in a gas heated boiler). This specific heat can be calculated by:

q=[(830331.6−253479.0)/(468.22−333.43)]*(T−333.43) or here q=4279.64*(T−333.43) J/kg

In the present case the specific warm up heat which can be coupled in does not exceed 576,852.6 J/kg respectively the warm up heat does not exceed 135,813.17 J.

Specific water conditions at the boiling point:

| P | T | V | X | H | U | s |
|---|---|---|---|---|---|---|
| N/m\hat{ }2 | K | m\hat{ }3/kg | — | J/kg | J/kg | J/kg K |
| 1400000.0 | 468.22 | 0.11489E−02 | 0.000 | 830331.6 | 828723.1 | 2284.25 |

Water is absorbing specific evaporation heat 2,790,057.2−830,331.6=1,959,725.6 J/kg or 1,959,725.6*0.23543826=461,394.39 J evaporation heat. To change from liquid to a gaseous state (feed water to saturated steam):

Specific volume changes from 0.11489E-02 m^{∧}3/kg to 0.14085 m^{∧}3/kg.

In present case we have to put (2790057.2−253479.0)*0.23543826=597,207.56 J heat in to get the saturated steam which is needed to move the water piston. Therefore, the 135,813.17 J warm up heat which can be coupled in at maximum by another source is only 22.74%.

Specific conditions of saturated (high-pressure) steam at the boiler exit:

| P | T | V | X | H | U | s | C |
|---|---|---|---|---|---|---|---|
| N/m\hat{ }2 | K | m\hat{ }3/kg | — | J/kg | J/kg | J/kg K | m/s |
| 1400000.0 | 468.22 | 0.14085 | 1.000 | 2790057.2 | 2592870.7 | 6469.33 | 0.043 |

Saturated steam is to be accelerated into the steam pipe (no losses assumed). Specific enthalpy change 2790057.2−2790038.2=19 J/kg and pressure change 14.0−13.998656=0.001344 bar.

Specific steam conditions at steam pipe entrance:

| P | T | V | X | H | U | s | C |
|---|---|---|---|---|---|---|---|
| N/m\hat{ }2 | K | m\hat{ }3/kg | — | J/kg | J/kg | J/kg K | m/s |
| 1399865.6 | 468.22 | 0.14086 | 1.000 | 2790038.2 | 2592854.0 | 6469.33 | 6.149 |

Pressure losses 1399865.6−1399751.0=0.001146 bar inside of steam pipe from boiler exit to steam inlet valve at water piston entrance. Specific enthalpy is constant (throttling process).

Specific steam conditions at steam valve:

| P | T | V | X | H | U | s | C |
|---|---|---|---|---|---|---|---|
| N/m\hat{ }2 | K | m\hat{ }3/kg | — | J/kg | J/kg | J/kg K | m/s |
| 1399751.0 | 468.22 | 0.14087 | 1.000 | 2790038.2 | 2592854.2 | 6469.36 | 6.150 |

Change of steam conditions by the abrupt area increase in front of the water piston at the top of the tank. Velocity changes from 6.15 m/s to 0.021 m/s. A pressure increase of 13.997519 bar−13.997510 bar=0.9 Pa (N/m^{∧}2). Specific enthalpy increase of 2,790,057.2−2,790,038.2=19 J/kg.

Specific steam conditions in front of the water-piston:

| P | T | V | X | H | U | s | C |
|---|---|---|---|---|---|---|---|
| N/m\hat{ }2 | K | m\hat{ }3/kg | — | J/kg | J/kg | J/kg K | m/s |
| 1399751.9 | 468.22 | 0.14087 | 2.000 | 2790057.2 | 2592870.5 | 6469.40 | 0.021 |

First the steam flows in with constant pressure in front of the water piston. In the present case the steam inlet valve will close when the mass has reached 235.43826 g. The steam than occupies a volume of 0.14087*0.23543826=0.03316619 m^{∧}3 and replaces a water mass of 0.03316619/0.10165E-02=32.6278 kg.

During this switching process work of 1399751.9*0.03316619=46,424.43 J passes from steam to water inside of the water piston cylinder. Out of this energy we get in our case useable mechanical work of 34,476.8 J which means there is an efficiency of 74.26% between work which is the piston getting from the in flowing steam and work which theoretical could be used.

Second, when the steam inlet valve is closed—the steam is expanding down to a pressure of 1.7 bar at the end before the steam outlet valve opens. The steam occupies a volume of 0.90268*0.23543826=0.21252541 m^{∧}3 and replaces a water mass of 0.21252540/0.10165E-02=208.8523 kg at the end.

During this expansion process the pressure inside the water piston cylinder decreases from 13.997519 to 1.7 bar, the specific volume of the steam increases from 0.14087 to 0.90268 m^{∧}3/kg and the specific internal energy of the steam decreases from 2592870.5−2269257.7 J/kg. The first thermodynamic law for closed systems states that the change of internal energy equals the work which is done by changing the volume and which in our case is passed over to the water piston—means: (2592870.5−2269257.7)*0.23543826=76,190.83 J.

Out of this energy we get turbine work calculated step by step. In our case useable mechanical work of 56,898.5 J which means there is an efficiency of 74.68% between work which is the piston is getting from the expanding steam and work which theoretical could be used.

All in all we get in our case usable mechanical work of 34,476.8+56,898.5=91375.3 J and we had to put heat in of (2790057.2−253479.0)*0.23543826=597,207.56 J. This leads to an efficiency of 15.3%.

Specific wet steam conditions with min. expansion pressure:

| P | T | V | X | H | U | s |
|---|---|---|---|---|---|---|
| N/m\hat{ }2 | K | m\hat{ }3/kg | — | J/kg | J/kg | J/kg K |
| 170000.0 | 388.32 | 0.90268 | 0.875 | 2422713.7 | 2269257.7 | 6469.40 |

After opening of the steam outlet valve the blow down takes place and during refilling of the water piston the wet steam is expelled. The pressure decreases from 1.7 bar to 0.372291 bar, the temperature decreases from 388.32 to 347.3 K and the specific volume increases from 0.90268 to 3.49 m^{∧}3/kg and the steam enthalpy inside the water piston cylinder decreases by 2,422,713.7*0.235438263−2,208,768.7*0.0000609722=570,264.83 J because most steam mass and therefore energy leaves the cylinder.

Specific wet steam conditions in the cylinder after blow down and expelling:

| P | T | V | X | H | U | s |
|---|---|---|---|---|---|---|
| N/m\hat{ }2 | K | m\hat{ }3/kg | — | J/kg | J/kg | J/kg K |
| 37229.1 | 347.30 | 3.4900 | 0.817 | 2208768.7 | 2078838.6 | 6470.73 |

During the blow down or expelling process the steam outlet valve is behaving like a throttle with constant pressure of 0.29 bar behind the throttle. In front of this throttle the pressure is decreasing from 1.7 bar to 0.372291 bar and the temperature is decreasing from 388.32 K to 341.48 K. The specific enthalpy of the wet steam does not change during this throttle process.

Specific wet steam conditions with condensation pressure:

| P | T | V | X | H | U | s |
|---|---|---|---|---|---|---|
| N/m\hat{ }2 | K | m\hat{ }3/kg | — | J/kg | J/kg | J/kg K |
| 29000.0 | 341.48 | 4.4396 | 0.822 | 2208768.7 | 2080019.5 | 6564.55 |

The steam mass is condensed within a condenser to change back from gas into the liquid state (wet steam into water). With constant pressure of 0.29 bar the temperature is decreasing from 341.48 to 333.15 K, the specific volume decreases from 4.4396 to 0.10171 E-02 m^{∧}3/kg and the enthalpy decreases by (2208768.7−251155.4)*0.235438263=460,897.07 J. This is in the present case of the energy which is released into the ambient.

Specific conditions in front of pump:

| P | T | V | X | H | U | s |
|---|---|---|---|---|---|---|
| N/m\hat{ }2 | K | m\hat{ }3/kg | — | J/kg | J/kg | J/kg K |
| 29000.0 | 333.15 | 0.10171E−02 | −2.000 | 251155.4 | 251125.9 | 831.16 |

If we want to consider that the heat to evaporate the feed-water (“heat input”) is partly delivered by our solar panel (“solar heat”) we could define the efficiency as follows:

$$Eta = \frac{Usable mechanical work}{Heat input - Solar heat}$$

$$Eta = \frac{Usable mechanical work}{Heat input} * \frac{1}{\{ 1 - ( Solar heat ) / ( Heat input ) \}}$$

If we look at our calculation above we find that the “solar heat” is less than 22% of the needed “heat input” so that we can write for the present case here:

Eta<15.3*1/(1−0.22)=19.61%

Water Cycle:

Displaced water mass during one cycle in this special case is 208.919 kg. Therefore with constant pressure of 13.997519 bar only 32.427 kg and during expansion of the steam=176.492 kg.

First the Part where the Steam is Flowing in with Constant Pressure:

Specific water conditions at water-piston top:

| P | T | V | X | H | U | s | C |
|---|---|---|---|---|---|---|---|
| N/m\hat{ }2 | K | m\hat{ }3/kg | — | J/kg | J/kg | J/kg K | m/s |
| 1399751.9 | 333.15 | 0.10165E−02 | −2.000 | 252304.7 | 250881.8 | 830.43 | 0.021 |

Specific water conditions at water-cylinder exit:

| P | T | V | X | H | U | s | C |
|---|---|---|---|---|---|---|---|
| N/m\hat{ }2 | K | m\hat{ }3/kg | — | J/kg | J/kg | J/kg K | m/s |
| 1411971.0 | 333.15 | 0.10165E−02 | −2.000 | 252317.1 | 250881.8 | 830.43 | 0.021 |

Specific water conditions in front of the nozzle:

| P | T | V | X | H | U | s | C |
|---|---|---|---|---|---|---|---|
| N/m\hat{ }2 | K | m\hat{ }3/kg | — | J/kg | J/kg | J/kg K | m/s |
| 1392520.9 | 333.15 | 0.10165E−02 | −2.000 | 252297.5 | 250882.0 | 830.43 | 0.384 |

Specific water conditions at nozzle exit:

| P | T | V | X | H | U | s | C |
|---|---|---|---|---|---|---|---|
| N/m\hat{ }2 | K | m\hat{ }3/kg | — | J/kg | J/kg | J/kg K | m/s |
| 29000.0 | 333.10 | 0.10171E−02 | −2.000 | 250939.2 | 250909.8 | 830.51 | 52.122 |

Second Part is where the Steam Expansion Takes Place See Below.

Some Mass, Power and Time Aspects:

Water masses and discharge time with const. steam pressure:

MpW=2.970 kg/s MW0=209.128 kg MW1=176.701 kg MWRest=0.209 kg

### DMWPvK=32.427 kg DMWExp=176.492 kg Time=10.9189 s

High pressure steam masses and load time:

### MpDa=21.430 g/s DelMDa=233.989 g MDtot=1.450 g MDampf=235.43826 g

### DTtot=0.06764 s LTime=10.9866 s

Low pressure steam masses:

### MmaxDa=235.4992371 g MExmDa=60.9112434 g MtotDa=1.4495692 g

### MDaRest=0.0609722 g DMAusb=174.5879974 g DMAuss=60.8502655 g

### MDaKon=235.4382629 g

Mass flows, power out- and input, heat flows:

MpW=2.96981 kg/s MpDa=21.42966 g/s PTu=−3207.64 W PTuis=−4034.05 W

### PPum=49.79 W QpDa=54357.99 W QpKon=−51219.90 W

Nozzle efficiency; turbine power; turbine efficiency:

### EtaD=97.968% PTu=−3207.64 W EtaT=79.514%

Power, work, heat flow, heat and efficiency without expansion:

### PTu=−3207.6 W WTu=−35023.9 J PPum=49.8 W WPum=547.1 J

### QpDa=54358.0 W QDa=597207.6 J QpKo=−51219.9 W QKomax=−562730.7 J

### PNu=−3157.8 W WNu=−34476.8 J Etath=5.773%

Behavior Before and During Steam Expansion:

| Time | PvK | MpW | MWEx | PNu | WNu | MpD | MDa | LDa | PvD | EtaT | CnD | CKo | CvD | vNDDa | Epsi | Ts(p) |
|---|---|---|---|---|---|---|---|---|---|---|---|---|---|---|---|---|
| s | bar | kg/s | kg | W | J | g/s | g | mm | bar | % | m/s | m/s | m/s | m\hat{ }3/kg | — | C |
| 0.000 | 0.3723 | 0.00 | 0.000 | 0.0 | 0.0 | 21.43 | 0.061 | 1.5 | 0.2900 | 0.00 | 0.00 | 0.000 | 0.00 | 0.0000 | 1.00 | 74.15 |
| 0.068 | 13.9975 | 2.97 | 0.000 | −3157.8 | 0.0 | 21.43 | 1.511 | 1.5 | 13.9252 | 79.51 | 52.12 | 0.021 | 0.38 | 0.1409 | 1.00 | 195.07 |
| 10.987 | 13.9975 | 2.97 | 32.427 | −3157.8 | −34476.9 | 21.43 | 235.499 | 233.9 | 13.9252 | 79.51 | 52.12 | 0.021 | 0.38 | 0.1409 | 1.00 | 195.07 |
| 11.072 | 13.8745 | 2.96 | 32.681 | −3190.2 | −34750.6 | 0.00 | 235.499 | 235.7 | 13.8021 | 79.62 | 51.89 | 0.021 | 0.38 | 0.1420 | 1.01 | 194.65 |
| 11.160 | 13.7516 | 2.94 | 32.940 | −3162.6 | −35027.4 | 0.00 | 235.499 | 237.5 | 13.6789 | 79.84 | 51.65 | 0.021 | 0.38 | 0.1431 | 1.02 | 194.24 |
| 11.249 | 13.6286 | 2.93 | 33.203 | −3135.0 | −35306.9 | 0.00 | 235.499 | 239.4 | 13.5558 | 80.05 | 51.41 | 0.021 | 0.38 | 0.1442 | 1.02 | 193.82 |
| 11.340 | 13.5056 | 2.92 | 33.471 | −3107.3 | −35589.4 | 0.00 | 235.499 | 241.3 | 13.4326 | 80.27 | 51.17 | 0.021 | 0.38 | 0.1454 | 1.03 | 193.40 |
| 11.433 | 13.3826 | 2.90 | 33.743 | −3079.6 | −35874.9 | 0.00 | 235.499 | 243.3 | 13.3095 | 80.49 | 50.93 | 0.021 | 0.38 | 0.1466 | 1.04 | 192.98 |
| 11.527 | 13.2597 | 2.89 | 34.020 | −3051.9 | −36163.4 | 0.00 | 235.499 | 245.3 | 13.1863 | 80.71 | 50.69 | 0.021 | 0.37 | 0.1477 | 1.05 | 192.55 |
| 11.624 | 13.1367 | 2.87 | 34.301 | −3024.1 | −36455.0 | 0.00 | 235.499 | 247.3 | 13.0632 | 80.94 | 50.45 | 0.021 | 0.37 | 0.1490 | 1.06 | 192.12 |
| 11.722 | 13.0137 | 2.86 | 34.588 | −2996.3 | −36749.7 | 0.00 | 235.499 | 249.3 | 12.9400 | 81.16 | 50.20 | 0.020 | 0.37 | 0.1502 | 1.07 | 191.69 |
| 11.822 | 12.8907 | 2.85 | 34.880 | −2968.5 | −37047.6 | 0.00 | 235.499 | 251.4 | 12.8169 | 81.39 | 49.96 | 0.020 | 0.37 | 0.1515 | 1.08 | 191.25 |
| 11.925 | 12.7678 | 2.83 | 35.177 | −2940.6 | −37348.7 | 0.00 | 235.499 | 253.6 | 12.6937 | 81.62 | 49.71 | 0.020 | 0.37 | 0.1527 | 1.08 | 190.81 |
| 12.029 | 12.6448 | 2.82 | 35.480 | −2912.6 | −37653.2 | 0.00 | 235.499 | 255.7 | 12.5705 | 81.85 | 49.47 | 0.020 | 0.36 | 0.1540 | 1.09 | 190.37 |
| 12.136 | 12.5218 | 2.80 | 35.788 | −2884.7 | −37961.1 | 0.00 | 235.499 | 257.9 | 12.4473 | 82.08 | 49.22 | 0.020 | 0.36 | 0.1554 | 1.10 | 189.92 |
| 12.245 | 12.3988 | 2.79 | 36.102 | −2856.7 | −38272.4 | 0.00 | 235.499 | 260.2 | 12.3242 | 82.32 | 48.97 | 0.020 | 0.36 | 0.1567 | 1.11 | 189.47 |
| 12.356 | 12.2759 | 2.78 | 36.421 | −2828.6 | −38587.2 | 0.00 | 235.499 | 262.5 | 12.2010 | 82.55 | 48.72 | 0.020 | 0.36 | 0.1581 | 1.12 | 189.02 |
| 12.470 | 12.1529 | 2.76 | 36.747 | −2800.6 | −38905.7 | 0.00 | 235.499 | 264.8 | 12.0778 | 82.79 | 48.46 | 0.020 | 0.36 | 0.1595 | 1.13 | 188.56 |
| 12.586 | 12.0299 | 2.75 | 37.079 | −2772.4 | −39227.7 | 0.00 | 235.499 | 267.2 | 11.9546 | 83.03 | 48.21 | 0.020 | 0.36 | 0.1610 | 1.14 | 188.10 |
| 12.705 | 11.9069 | 2.73 | 37.418 | −2744.3 | −39553.6 | 0.00 | 235.499 | 269.6 | 11.8314 | 83.27 | 47.95 | 0.020 | 0.35 | 0.1624 | 1.15 | 187.64 |
| 12.826 | 11.7840 | 2.72 | 37.763 | −2716.1 | −39883.2 | 0.00 | 235.499 | 272.1 | 11.7082 | 83.51 | 47.70 | 0.019 | 0.35 | 0.1639 | 1.16 | 187.17 |
| 12.950 | 11.6610 | 2.70 | 38.115 | −2687.8 | −40216.7 | 0.00 | 235.499 | 274.6 | 11.5850 | 83.75 | 47.44 | 0.019 | 0.35 | 0.1654 | 1.17 | 186.70 |
| 13.077 | 11.5380 | 2.69 | 38.474 | −2659.5 | −40554.2 | 0.00 | 235.499 | 277.2 | 11.4618 | 84.00 | 47.18 | 0.019 | 0.35 | 0.1670 | 1.19 | 186.22 |
| 13.207 | 11.4150 | 2.67 | 38.840 | −2631.2 | −40895.7 | 0.00 | 235.499 | 279.8 | 11.3386 | 84.25 | 46.92 | 0.019 | 0.35 | 0.1686 | 1.20 | 185.74 |
| 13.340 | 11.2921 | 2.66 | 39.214 | −2602.8 | −41241.3 | 0.00 | 235.499 | 282.5 | 11.2154 | 84.50 | 46.66 | 0.019 | 0.34 | 0.1702 | 1.21 | 185.26 |
| 13.476 | 11.1691 | 2.64 | 39.595 | −2574.4 | −41591.2 | 0.00 | 235.499 | 285.2 | 11.0921 | 84.75 | 46.39 | 0.019 | 0.34 | 0.1718 | 1.22 | 184.77 |
| 13.615 | 11.0461 | 2.63 | 39.985 | −2545.9 | −41945.4 | 0.00 | 235.499 | 288.0 | 10.9689 | 85.00 | 46.13 | 0.019 | 0.34 | 0.1735 | 1.23 | 184.28 |
| 13.757 | 10.9231 | 2.61 | 40.382 | −2517.4 | −42304.0 | 0.00 | 235.499 | 290.9 | 10.8457 | 85.26 | 45.86 | 0.019 | 0.34 | 0.1752 | 1.24 | 183.78 |
| 13.903 | 10.8002 | 2.60 | 40.788 | −2488.8 | −42667.1 | 0.00 | 235.499 | 293.8 | 10.7224 | 85.51 | 45.59 | 0.019 | 0.34 | 0.1770 | 1.26 | 183.28 |
| 14.053 | 10.6772 | 2.58 | 41.203 | −2460.2 | −43034.7 | 0.00 | 235.499 | 296.7 | 10.5992 | 85.77 | 45.32 | 0.019 | 0.33 | 0.1788 | 1.27 | 182.78 |
| 14.206 | 10.5542 | 2.57 | 41.627 | −2431.5 | −43407.1 | 0.00 | 235.499 | 299.8 | 10.4759 | 86.03 | 45.05 | 0.018 | 0.33 | 0.1806 | 1.28 | 182.27 |
| 14.363 | 10.4312 | 2.55 | 42.061 | −2402.7 | −43784.3 | 0.00 | 235.499 | 302.9 | 10.3527 | 86.29 | 44.78 | 0.018 | 0.33 | 0.1825 | 1.30 | 181.75 |
| 14.524 | 10.3083 | 2.54 | 42.504 | −2374.0 | −44166.4 | 0.00 | 235.499 | 306.1 | 10.2294 | 86.55 | 44.50 | 0.018 | 0.33 | 0.1844 | 1.31 | 181.23 |
| 14.689 | 10.1853 | 2.52 | 42.957 | −2345.1 | −44553.5 | 0.00 | 235.499 | 309.3 | 10.1061 | 86.82 | 44.23 | 0.018 | 0.33 | 0.1863 | 1.32 | 180.71 |
| 14.858 | 10.0623 | 2.50 | 43.420 | −2316.2 | −44945.7 | 0.00 | 235.499 | 312.6 | 9.9828 | 87.08 | 43.95 | 0.018 | 0.32 | 0.1883 | 1.34 | 180.18 |
| 15.032 | 9.9393 | 2.49 | 43.894 | −2287.3 | −45343.2 | 0.00 | 235.499 | 316.0 | 9.8596 | 87.35 | 43.67 | 0.018 | 0.32 | 0.1904 | 1.35 | 179.65 |
| 15.210 | 9.8164 | 2.47 | 44.380 | −2258.3 | −45746.0 | 0.00 | 235.499 | 319.5 | 9.7363 | 87.62 | 43.39 | 0.018 | 0.32 | 0.1925 | 1.37 | 179.11 |
| 15.393 | 9.6934 | 2.46 | 44.877 | −2229.2 | −46154.4 | 0.00 | 235.499 | 323.1 | 9.6130 | 87.89 | 43.10 | 0.018 | 0.32 | 0.1946 | 1.38 | 178.56 |
| 15.582 | 9.5704 | 2.44 | 45.386 | −2200.1 | −46568.4 | 0.00 | 235.499 | 326.7 | 9.4896 | 88.16 | 42.82 | 0.017 | 0.32 | 0.1968 | 1.40 | 178.01 |
| 15.775 | 9.4474 | 2.42 | 45.907 | −2170.9 | −46988.1 | 0.00 | 235.499 | 330.5 | 9.3663 | 88.43 | 42.53 | 0.017 | 0.31 | 0.1991 | 1.41 | 177.45 |
| 15.974 | 9.3245 | 2.41 | 46.441 | −2141.7 | −47413.8 | 0.00 | 235.499 | 334.3 | 9.2430 | 88.71 | 42.24 | 0.017 | 0.31 | 0.2014 | 1.43 | 176.89 |
| 16.178 | 9.2015 | 2.39 | 46.989 | −2112.4 | −47845.5 | 0.00 | 235.499 | 338.2 | 9.1197 | 88.98 | 41.95 | 0.017 | 0.31 | 0.2037 | 1.45 | 176.32 |
| 16.388 | 9.0785 | 2.37 | 47.551 | −2083.0 | −48283.3 | 0.00 | 235.499 | 342.2 | 8.9963 | 89.26 | 41.65 | 0.017 | 0.31 | 0.2062 | 1.46 | 175.75 |
| 16.605 | 8.9555 | 2.36 | 48.127 | −2053.6 | −48727.6 | 0.00 | 235.499 | 346.4 | 8.8729 | 89.53 | 41.36 | 0.017 | 0.31 | 0.2086 | 1.48 | 175.17 |
| 16.827 | 8.8326 | 2.34 | 48.718 | −2024.1 | −49178.3 | 0.00 | 235.499 | 350.6 | 8.7496 | 89.81 | 41.06 | 0.017 | 0.30 | 0.2112 | 1.50 | 174.58 |
| 17.057 | 8.7096 | 2.32 | 49.325 | −1994.5 | −49635.7 | 0.00 | 235.499 | 354.9 | 8.6262 | 90.09 | 40.76 | 0.017 | 0.30 | 0.2138 | 1.52 | 173.99 |
| 17.293 | 8.5866 | 2.30 | 49.948 | −1964.9 | −50099.9 | 0.00 | 235.499 | 359.4 | 8.5028 | 90.37 | 40.45 | 0.017 | 0.30 | 0.2165 | 1.54 | 173.39 |
| 17.536 | 8.4636 | 2.29 | 50.588 | −1935.1 | −50571.1 | 0.00 | 235.499 | 364.0 | 8.3794 | 90.65 | 40.15 | 0.016 | 0.30 | 0.2193 | 1.56 | 172.79 |
| 17.787 | 8.3407 | 2.27 | 51.246 | −1905.4 | −51049.5 | 0.00 | 235.499 | 368.7 | 8.2560 | 90.93 | 39.84 | 0.016 | 0.29 | 0.2221 | 1.58 | 172.17 |
| 18.046 | 8.2177 | 2.25 | 51.922 | −1875.5 | −51535.3 | 0.00 | 235.499 | 373.6 | 8.1326 | 91.21 | 39.53 | 0.016 | 0.29 | 0.2250 | 1.60 | 171.55 |
| 18.314 | 8.0947 | 2.23 | 52.618 | −1845.5 | −52028.6 | 0.00 | 235.499 | 378.6 | 8.0091 | 91.49 | 39.22 | 0.016 | 0.29 | 0.2280 | 1.62 | 170.92 |
| 18.590 | 7.9717 | 2.22 | 53.333 | −1815.5 | −52529.7 | 0.00 | 235.499 | 383.7 | 7.8857 | 91.76 | 38.90 | 0.016 | 0.29 | 0.2311 | 1.64 | 170.29 |
| 18.875 | 7.8488 | 2.20 | 54.070 | −1785.4 | −53038.8 | 0.00 | 235.499 | 389.0 | 7.7622 | 92.04 | 38.59 | 0.016 | 0.28 | 0.2343 | 1.66 | 169.65 |
| 19.170 | 7.7258 | 2.18 | 54.829 | −1755.2 | −53556.1 | 0.00 | 235.499 | 394.4 | 7.6387 | 92.32 | 38.27 | 0.016 | 0.28 | 0.2376 | 1.69 | 169.00 |
| 19.474 | 7.6028 | 2.16 | 55.611 | −1725.0 | −54081.7 | 0.00 | 235.499 | 400.0 | 7.5152 | 92.60 | 37.94 | 0.015 | 0.28 | 0.2410 | 1.71 | 168.34 |
| 19.790 | 7.4798 | 2.14 | 56.417 | −1694.6 | −54616.0 | 0.00 | 235.499 | 405.8 | 7.3917 | 92.87 | 37.62 | 0.015 | 0.28 | 0.2444 | 1.74 | 167.67 |
| 20.116 | 7.3569 | 2.12 | 57.248 | −1664.2 | −55159.1 | 0.00 | 235.499 | 411.7 | 7.2681 | 93.14 | 37.29 | 0.015 | 0.28 | 0.2480 | 1.76 | 166.99 |
| 20.454 | 7.2339 | 2.11 | 58.106 | −1633.6 | −55711.4 | 0.00 | 235.499 | 417.9 | 7.1446 | 93.41 | 36.96 | 0.015 | 0.27 | 0.2517 | 1.79 | 166.31 |
| 20.804 | 7.1109 | 2.09 | 58.992 | −1603.0 | −56273.0 | 0.00 | 235.499 | 424.2 | 7.0210 | 93.68 | 36.62 | 0.015 | 0.27 | 0.2556 | 1.81 | 165.61 |
| 21.168 | 6.9879 | 2.07 | 59.907 | −1572.2 | −56844.2 | 0.00 | 235.499 | 430.8 | 6.8974 | 93.94 | 36.29 | 0.015 | 0.27 | 0.2595 | 1.84 | 164.91 |
| 21.545 | 6.8650 | 2.05 | 60.853 | −1541.4 | −57425.3 | 0.00 | 235.499 | 437.6 | 6.7738 | 94.20 | 35.95 | 0.015 | 0.27 | 0.2636 | 1.87 | 164.19 |
| 21.936 | 6.7420 | 2.03 | 61.831 | −1510.5 | −58016.6 | 0.00 | 235.499 | 444.6 | 6.6502 | 94.46 | 35.60 | 0.015 | 0.26 | 0.2678 | 1.90 | 163.47 |
| 22.343 | 6.6190 | 2.01 | 62.844 | −1479.4 | −58618.3 | 0.00 | 235.499 | 451.8 | 6.5265 | 94.71 | 35.25 | 0.014 | 0.26 | 0.2722 | 1.93 | 162.73 |
| 22.766 | 6.4960 | 1.99 | 63.892 | −1448.3 | −59230.7 | 0.00 | 235.499 | 459.4 | 6.4028 | 94.95 | 34.90 | 0.014 | 0.26 | 0.2767 | 1.96 | 161.98 |
| 23.206 | 6.3731 | 1.97 | 64.978 | −1417.0 | −59854.2 | 0.00 | 235.499 | 467.2 | 6.2791 | 95.19 | 34.55 | 0.014 | 0.25 | 0.2814 | 2.00 | 161.23 |
| 23.664 | 6.2501 | 1.95 | 66.105 | −1385.6 | −60489.1 | 0.00 | 235.499 | 475.2 | 6.1554 | 95.42 | 34.19 | 0.014 | 0.25 | 0.2863 | 2.03 | 160.46 |
| 24.141 | 6.1271 | 1.93 | 67.274 | −1354.1 | −61135.6 | 0.00 | 235.499 | 483.6 | 6.0316 | 95.64 | 33.83 | 0.014 | 0.25 | 0.2913 | 2.07 | 159.68 |
| 24.639 | 6.0041 | 1.91 | 68.488 | −1322.4 | −61794.2 | 0.00 | 235.499 | 492.3 | 5.9078 | 95.85 | 33.46 | 0.014 | 0.25 | 0.2966 | 2.11 | 158.88 |
| 25.159 | 5.8812 | 1.89 | 69.750 | −1290.7 | −62465.1 | 0.00 | 235.499 | 501.4 | 5.7840 | 96.05 | 33.09 | 0.014 | 0.24 | 0.3020 | 2.14 | 158.07 |
| 25.702 | 5.7582 | 1.86 | 71.063 | −1258.8 | −63148.7 | 0.00 | 235.499 | 510.8 | 5.6601 | 96.23 | 32.71 | 0.013 | 0.24 | 0.3077 | 2.18 | 157.25 |
| 26.270 | 5.6352 | 1.84 | 72.429 | −1226.7 | −63845.3 | 0.00 | 235.499 | 520.6 | 5.5362 | 96.40 | 32.33 | 0.013 | 0.24 | 0.3136 | 2.23 | 156.42 |
| 26.865 | 5.5122 | 1.82 | 73.853 | −1194.5 | −64555.3 | 0.00 | 235.499 | 530.8 | 5.4122 | 96.55 | 31.95 | 0.013 | 0.24 | 0.3197 | 2.27 | 155.57 |
| 27.487 | 5.3893 | 1.80 | 75.338 | −1162.2 | −65279.1 | 0.00 | 235.499 | 541.4 | 5.2883 | 96.69 | 31.56 | 0.013 | 0.23 | 0.3261 | 2.32 | 154.70 |
| 28.141 | 5.2663 | 1.78 | 76.887 | −1129.7 | −66017.1 | 0.00 | 235.499 | 552.5 | 5.1642 | 96.80 | 31.17 | 0.013 | 0.23 | 0.3328 | 2.36 | 153.82 |
| 28.827 | 5.1433 | 1.75 | 78.507 | −1097.0 | −66769.5 | 0.00 | 235.499 | 564.1 | 5.0401 | 96.89 | 30.77 | 0.013 | 0.23 | 0.3398 | 2.41 | 152.93 |
| 29.548 | 5.0203 | 1.73 | 80.201 | −1064.2 | −67536.7 | 0.00 | 235.499 | 576.3 | 4.9160 | 96.95 | 30.36 | 0.012 | 0.22 | 0.3471 | 2.46 | 152.01 |
| 30.306 | 4.8974 | 1.71 | 81.976 | −1031.2 | −68319.2 | 0.00 | 235.499 | 589.0 | 4.7918 | 96.98 | 29.95 | 0.012 | 0.22 | 0.3548 | 2.52 | 151.08 |
| 31.106 | 4.7744 | 1.68 | 83.836 | −998.0 | −69117.2 | 0.00 | 235.499 | 602.3 | 4.6676 | 96.98 | 29.54 | 0.012 | 0.22 | 0.3628 | 2.58 | 150.13 |
| 31.950 | 4.6514 | 1.66 | 85.789 | −964.6 | −69931.1 | 0.00 | 235.499 | 616.3 | 4.5433 | 96.93 | 29.11 | 0.012 | 0.21 | 0.3713 | 2.64 | 149.16 |
| 32.841 | 4.5284 | 1.63 | 87.841 | −931.0 | −70761.1 | 0.00 | 235.499 | 631.0 | 4.4189 | 96.84 | 28.68 | 0.012 | 0.21 | 0.3801 | 2.70 | 148.16 |
| 33.785 | 4.4055 | 1.61 | 90.001 | −897.2 | −71607.5 | 0.00 | 235.499 | 646.5 | 4.2944 | 96.70 | 28.25 | 0.012 | 0.21 | 0.3895 | 2.76 | 147.15 |
| 34.785 | 4.2825 | 1.58 | 92.278 | −863.1 | −72470.6 | 0.00 | 235.499 | 662.8 | 4.1699 | 96.50 | 27.81 | 0.011 | 0.21 | 0.3993 | 2.83 | 146.11 |
| 35.846 | 4.1595 | 1.56 | 94.682 | −828.9 | −73350.5 | 0.00 | 235.499 | 680.1 | 4.0453 | 96.24 | 27.36 | 0.011 | 0.20 | 0.4097 | 2.91 | 145.05 |
| 36.975 | 4.0365 | 1.53 | 97.223 | −794.3 | −74247.2 | 0.00 | 235.499 | 698.3 | 3.9205 | 95.90 | 26.90 | 0.011 | 0.20 | 0.4206 | 2.99 | 143.96 |
| 38.178 | 3.9136 | 1.51 | 99.915 | −759.5 | −75160.8 | 0.00 | 235.499 | 717.6 | 3.7957 | 95.47 | 26.43 | 0.011 | 0.20 | 0.4323 | 3.07 | 142.85 |
| 39.462 | 3.7906 | 1.48 | 102.771 | −724.5 | −76091.0 | 0.00 | 235.499 | 738.1 | 3.6708 | 94.94 | 25.96 | 0.011 | 0.19 | 0.4446 | 3.16 | 141.71 |
| 40.835 | 3.6676 | 1.45 | 105.807 | −689.1 | −77037.5 | 0.00 | 235.499 | 759.8 | 3.5457 | 94.29 | 25.47 | 0.010 | 0.19 | 0.4577 | 3.25 | 140.53 |
| 42.308 | 3.5446 | 1.42 | 109.042 | −653.4 | −77999.7 | 0.00 | 235.499 | 783.0 | 3.4205 | 93.51 | 24.98 | 0.010 | 0.18 | 0.4717 | 3.35 | 139.33 |
| 43.891 | 3.4217 | 1.39 | 112.495 | −617.4 | −78976.9 | 0.00 | 235.499 | 807.8 | 3.2952 | 92.57 | 24.47 | 0.010 | 0.18 | 0.4866 | 3.45 | 138.09 |
| 45.596 | 3.2987 | 1.36 | 116.191 | −581.0 | −79967.7 | 0.00 | 235.499 | 834.3 | 3.1697 | 91.45 | 23.96 | 0.010 | 0.18 | 0.5026 | 3.57 | 136.82 |
| 47.438 | 3.1757 | 1.33 | 120.156 | −544.3 | −80970.4 | 0.00 | 235.499 | 862.7 | 3.0440 | 90.11 | 23.43 | 0.010 | 0.17 | 0.5197 | 3.69 | 135.50 |
| 49.434 | 3.0527 | 1.30 | 124.422 | −507.1 | −81982.7 | 0.00 | 235.499 | 893.3 | 2.9181 | 88.51 | 22.89 | 0.009 | 0.17 | 0.5381 | 3.82 | 134.14 |
| 51.605 | 2.9298 | 1.27 | 129.025 | −469.5 | −83001.6 | 0.00 | 235.499 | 926.3 | 2.7919 | 86.61 | 22.33 | 0.009 | 0.16 | 0.5580 | 3.96 | 132.74 |
| 53.972 | 2.8068 | 1.24 | 134.008 | −431.4 | −84022.8 | 0.00 | 235.499 | 962.0 | 2.6655 | 84.35 | 21.76 | 0.009 | 0.16 | 0.5795 | 4.11 | 131.29 |
| 56.565 | 2.6838 | 1.21 | 139.421 | −392.7 | −85040.8 | 0.00 | 235.499 | 1000.8 | 2.5388 | 81.65 | 21.17 | 0.009 | 0.16 | 0.6029 | 4.28 | 129.79 |
| 59.415 | 2.5608 | 1.17 | 145.324 | −353.5 | −86048.3 | 0.00 | 235.499 | 1043.1 | 2.4118 | 78.40 | 20.56 | 0.008 | 0.15 | 0.6284 | 4.46 | 128.23 |
| 62.563 | 2.4379 | 1.14 | 151.787 | −313.6 | −87035.6 | 0.00 | 235.499 | 1089.5 | 2.2843 | 74.50 | 19.94 | 0.008 | 0.15 | 0.6563 | 4.66 | 126.61 |
| 66.059 | 2.3149 | 1.10 | 158.897 | −272.9 | −87989.5 | 0.00 | 235.499 | 1140.4 | 2.1565 | 69.77 | 19.29 | 0.008 | 0.14 | 0.6870 | 4.88 | 124.92 |
| 69.960 | 2.1919 | 1.06 | 166.759 | −231.5 | −88892.8 | 0.00 | 235.499 | 1196.8 | 2.0281 | 64.00 | 18.61 | 0.008 | 0.14 | 0.7209 | 5.12 | 123.16 |
| 74.342 | 2.0689 | 1.02 | 175.501 | −189.2 | −89721.8 | 0.00 | 235.499 | 1259.5 | 1.8990 | 56.89 | 17.91 | 0.007 | 0.13 | 0.7587 | 5.39 | 121.31 |
| 79.298 | 1.9460 | 0.98 | 185.284 | −145.8 | −90444.5 | 0.00 | 235.499 | 1329.6 | 1.7693 | 48.03 | 17.17 | 0.007 | 0.13 | 0.8009 | 5.69 | 119.37 |
| 84.947 | 1.8230 | 0.93 | 196.311 | −101.2 | −91016.4 | 0.00 | 235.499 | 1408.7 | 1.6387 | 36.83 | 16.39 | 0.007 | 0.12 | 0.8486 | 6.02 | 117.33 |
| 91.443 | 1.7000 | 0.89 | 208.840 | −55.3 | −91375.3 | 0.00 | 235.499 | 1498.5 | 1.5071 | 22.43 | 15.57 | 0.006 | 0.11 | 0.9027 | 6.41 | 115.17 |

Overall Cycle Results:

### WNutz=−91375.3 J PNutzm=−1000.00 W QDa=597207.6 J QpDam=6530.90 W

### QKomax=−505832.2 J QpKom=−5531.64 W MW=208.840 kg MDampf=235.438 g

### WTime=91.38 s Etath=15.300%

### WTu=−91922.4 J PTum=−1005.98 W WTuis=−111302.2 J PTuism=−1218.07 W

### EtaTm=82.588%

Behavior During Blow Down and Refilling:

| Time | PvK | MpW | MWa | VWa | VDa | MpD | MDa | LWa | PvD | TvKD | XvK | CnD | CvD | C-Pis | CWin |
|---|---|---|---|---|---|---|---|---|---|---|---|---|---|---|---|
| s | bar | kg/s | kg | m\hat{ }3 | m\hat{ }3 | g/s | g | mm | bar | C | — | m/s | m/s | m/s | m/s |
| 0.0000 | 1.70000 | 0.00 | 0.209 | 0.000213 | 0.212581 | 0.00 | 235.499 | 1.5 | 1.70000 | 115.17 | 0.875 | 0.00 | 0.00 | 0.0000 | 0.000 |
| 0.0000 | 1.70000 | 0.00 | 0.209 | 0.000213 | 0.212581 | 14.05 | 235.499 | 1.5 | 1.69518 | 115.17 | 0.875 | 413.38 | 25.90 | 0.0000 | 0.000 |
| 1.0594 | 1.58310 | 0.00 | 0.209 | 0.000213 | 0.212581 | 13.13 | 221.100 | 1.5 | 1.57861 | 113.00 | 0.872 | 411.23 | 25.79 | 0.0000 | 0.000 |
| 2.2058 | 1.46619 | 0.00 | 0.209 | 0.000213 | 0.212581 | 12.21 | 206.571 | 1.5 | 1.46204 | 110.69 | 0.869 | 408.94 | 25.67 | 0.0000 | 0.000 |
| 3.4541 | 1.34929 | 0.00 | 0.209 | 0.000213 | 0.212581 | 11.29 | 191.901 | 1.5 | 1.34547 | 108.23 | 0.865 | 406.48 | 25.54 | 0.0000 | 0.000 |
| 4.8235 | 1.23239 | 0.00 | 0.209 | 0.000213 | 0.212581 | 10.36 | 177.077 | 1.5 | 1.22890 | 105.58 | 0.862 | 403.84 | 25.40 | 0.0000 | 0.000 |
| 6.3390 | 1.11549 | 0.00 | 0.209 | 0.000213 | 0.212581 | 9.43 | 162.084 | 1.5 | 1.11233 | 102.71 | 0.857 | 400.97 | 25.25 | 0.0000 | 0.000 |
| 8.0341 | 0.99858 | 0.00 | 0.209 | 0.000213 | 0.212581 | 8.49 | 146.901 | 1.5 | 0.99575 | 99.59 | 0.853 | 397.82 | 25.08 | 0.0000 | 0.000 |
| 9.9551 | 0.88168 | 0.00 | 0.209 | 0.000213 | 0.212581 | 7.54 | 131.506 | 1.5 | 0.87918 | 96.14 | 0.848 | 394.35 | 24.90 | 0.0000 | 0.000 |
| 12.1687 | 0.76478 | 0.00 | 0.209 | 0.000213 | 0.212581 | 6.59 | 115.867 | 1.5 | 0.76261 | 92.30 | 0.843 | 390.44 | 24.69 | 0.0000 | 0.000 |
| 14.7752 | 0.64788 | 0.00 | 0.209 | 0.000213 | 0.212581 | 5.63 | 99.944 | 1.5 | 0.64604 | 87.93 | 0.836 | 385.99 | 24.45 | 0.0000 | 0.000 |
| 17.9369 | 0.53097 | 0.00 | 0.209 | 0.000213 | 0.212581 | 4.66 | 83.682 | 1.5 | 0.52947 | 82.84 | 0.829 | 380.77 | 24.17 | 0.0000 | 0.000 |
| 18.7742 | 0.51012 | 11.61 | 2.504 | 0.002547 | 0.210247 | 4.48 | 79.854 | 18.0 | 0.50867 | 81.83 | 0.828 | 379.74 | 24.11 | 0.0832 | 1.503 |
| 19.0210 | 0.50854 | 11.61 | 4.798 | 0.004880 | 0.207914 | 4.47 | 78.750 | 34.4 | 0.50710 | 81.76 | 0.828 | 379.66 | 24.11 | 0.0832 | 1.503 |
| 19.2674 | 0.50696 | 11.60 | 7.093 | 0.007214 | 0.205580 | 4.46 | 77.650 | 50.9 | 0.50552 | 81.68 | 0.828 | 379.58 | 24.11 | 0.0832 | 1.503 |
| 19.5134 | 0.50538 | 11.60 | 9.387 | 0.009548 | 0.203246 | 4.44 | 76.554 | 67.3 | 0.50395 | 81.60 | 0.828 | 379.49 | 24.10 | 0.0832 | 1.502 |
| 19.7591 | 0.50380 | 11.60 | 11.681 | 0.011881 | 0.200912 | 4.43 | 75.464 | 83.8 | 0.50237 | 81.52 | 0.827 | 379.41 | 24.10 | 0.0832 | 1.502 |
| 20.0044 | 0.50222 | 11.60 | 13.976 | 0.014215 | 0.198579 | 4.42 | 74.378 | 100.2 | 0.50079 | 81.44 | 0.827 | 379.33 | 24.09 | 0.0832 | 1.502 |
| 20.2494 | 0.50064 | 11.60 | 16.270 | 0.016549 | 0.196245 | 4.41 | 73.298 | 116.7 | 0.49922 | 81.37 | 0.827 | 379.25 | 24.09 | 0.0831 | 1.502 |
| 20.4940 | 0.49906 | 11.59 | 18.565 | 0.018883 | 0.193911 | 4.39 | 72.222 | 133.1 | 0.49764 | 81.29 | 0.827 | 379.17 | 24.08 | 0.0831 | 1.501 |
| 20.7382 | 0.49748 | 11.59 | 20.859 | 0.021216 | 0.191578 | 4.38 | 71.151 | 149.6 | 0.49607 | 81.21 | 0.827 | 379.09 | 24.08 | 0.0831 | 1.501 |
| 20.9820 | 0.49591 | 11.59 | 23.153 | 0.023550 | 0.189244 | 4.37 | 70.085 | 166.0 | 0.49450 | 81.13 | 0.827 | 378.69 | 24.07 | 0.0831 | 1.501 |
| 21.2252 | 0.49434 | 11.58 | 25.448 | 0.025884 | 0.186910 | 4.35 | 69.025 | 182.5 | 0.49293 | 81.05 | 0.827 | 377.45 | 24.06 | 0.0830 | 1.500 |
| 21.4681 | 0.49277 | 11.58 | 27.742 | 0.028217 | 0.184576 | 4.34 | 67.970 | 198.9 | 0.49137 | 80.97 | 0.827 | 376.20 | 24.05 | 0.0830 | 1.499 |
| 21.7107 | 0.49120 | 11.57 | 30.037 | 0.030551 | 0.182243 | 4.32 | 66.920 | 215.4 | 0.48981 | 80.89 | 0.827 | 374.95 | 24.04 | 0.0830 | 1.499 |
| 21.9530 | 0.48963 | 11.57 | 32.331 | 0.032885 | 0.179909 | 4.31 | 65.875 | 231.8 | 0.48825 | 80.81 | 0.826 | 373.70 | 24.03 | 0.0829 | 1.498 |
| 22.1949 | 0.48807 | 11.56 | 34.626 | 0.035219 | 0.177575 | 4.29 | 64.834 | 248.3 | 0.48669 | 80.73 | 0.826 | 372.43 | 24.01 | 0.0829 | 1.497 |
| 22.4366 | 0.48650 | 11.55 | 36.920 | 0.037552 | 0.175242 | 4.28 | 63.799 | 264.7 | 0.48513 | 80.65 | 0.826 | 371.17 | 24.00 | 0.0828 | 1.496 |
| 22.6779 | 0.48494 | 11.55 | 39.214 | 0.039886 | 0.172908 | 4.26 | 62.768 | 281.2 | 0.48357 | 80.57 | 0.826 | 369.89 | 23.98 | 0.0828 | 1.495 |
| 22.9189 | 0.48337 | 11.54 | 41.509 | 0.042220 | 0.170574 | 4.25 | 61.743 | 297.6 | 0.48201 | 80.49 | 0.826 | 368.61 | 23.97 | 0.0827 | 1.494 |
| 23.1596 | 0.48181 | 11.53 | 43.803 | 0.044553 | 0.168240 | 4.23 | 60.722 | 314.1 | 0.48045 | 80.41 | 0.826 | 367.32 | 23.96 | 0.0827 | 1.493 |
| 23.4000 | 0.48025 | 11.52 | 46.098 | 0.046887 | 0.165907 | 4.22 | 59.706 | 330.5 | 0.47889 | 80.33 | 0.826 | 366.03 | 23.94 | 0.0826 | 1.492 |
| 23.6401 | 0.47869 | 11.52 | 48.392 | 0.049221 | 0.163573 | 4.20 | 58.695 | 347.0 | 0.47734 | 80.25 | 0.826 | 364.73 | 23.92 | 0.0826 | 1.491 |
| 23.8799 | 0.47712 | 11.51 | 50.686 | 0.051555 | 0.161239 | 4.19 | 57.689 | 363.4 | 0.47578 | 80.17 | 0.825 | 363.43 | 23.91 | 0.0825 | 1.490 |
| 24.1194 | 0.47556 | 11.50 | 52.981 | 0.053888 | 0.158906 | 4.17 | 56.688 | 379.9 | 0.47423 | 80.09 | 0.825 | 362.12 | 23.89 | 0.0825 | 1.489 |
| 24.3586 | 0.47400 | 11.49 | 55.275 | 0.056222 | 0.156572 | 4.16 | 55.692 | 396.3 | 0.47267 | 80.01 | 0.825 | 360.80 | 23.87 | 0.0824 | 1.488 |
| 24.5975 | 0.47245 | 11.48 | 57.570 | 0.058556 | 0.154238 | 4.14 | 54.700 | 412.8 | 0.47112 | 79.93 | 0.825 | 359.48 | 23.86 | 0.0823 | 1.487 |
| 24.8361 | 0.47089 | 11.47 | 59.864 | 0.060889 | 0.151904 | 4.13 | 53.714 | 429.2 | 0.46957 | 79.85 | 0.825 | 358.15 | 23.84 | 0.0823 | 1.486 |
| 25.0743 | 0.46933 | 11.47 | 62.159 | 0.063223 | 0.149571 | 4.11 | 52.732 | 445.7 | 0.46802 | 79.76 | 0.825 | 356.81 | 23.82 | 0.0822 | 1.485 |
| 25.3123 | 0.46777 | 11.46 | 64.453 | 0.065557 | 0.147237 | 4.10 | 51.756 | 462.1 | 0.46647 | 79.68 | 0.825 | 355.47 | 23.80 | 0.0821 | 1.484 |
| 25.5500 | 0.46622 | 11.45 | 66.747 | 0.067891 | 0.144903 | 4.08 | 50.784 | 478.6 | 0.46492 | 79.60 | 0.825 | 354.12 | 23.78 | 0.0821 | 1.482 |
| 25.7875 | 0.46466 | 11.44 | 69.042 | 0.070224 | 0.142570 | 4.06 | 49.817 | 495.0 | 0.46337 | 79.52 | 0.825 | 352.76 | 23.76 | 0.0820 | 1.481 |
| 26.0246 | 0.46311 | 11.43 | 71.336 | 0.072558 | 0.140236 | 4.05 | 48.855 | 511.5 | 0.46182 | 79.44 | 0.824 | 351.40 | 23.74 | 0.0819 | 1.480 |
| 26.2614 | 0.46156 | 11.42 | 73.631 | 0.074892 | 0.137902 | 4.03 | 47.898 | 527.9 | 0.46027 | 79.35 | 0.824 | 350.03 | 23.71 | 0.0818 | 1.478 |
| 26.4980 | 0.46001 | 11.40 | 75.925 | 0.077225 | 0.135568 | 4.02 | 46.946 | 544.4 | 0.45873 | 79.27 | 0.824 | 348.65 | 23.69 | 0.0818 | 1.477 |
| 26.7343 | 0.45846 | 11.39 | 78.219 | 0.079559 | 0.133235 | 4.00 | 45.999 | 560.8 | 0.45718 | 79.19 | 0.824 | 347.26 | 23.67 | 0.0817 | 1.475 |
| 26.9703 | 0.45691 | 11.38 | 80.514 | 0.081893 | 0.130901 | 3.98 | 45.056 | 577.3 | 0.45564 | 79.10 | 0.824 | 345.87 | 23.64 | 0.0816 | 1.474 |
| 27.2060 | 0.45536 | 11.37 | 82.808 | 0.084227 | 0.128567 | 3.97 | 44.119 | 593.7 | 0.45410 | 79.02 | 0.824 | 344.47 | 23.62 | 0.0815 | 1.472 |
| 27.4415 | 0.45381 | 11.36 | 85.103 | 0.086560 | 0.126234 | 3.95 | 43.186 | 610.2 | 0.45256 | 78.94 | 0.824 | 343.06 | 23.59 | 0.0814 | 1.471 |
| 27.6766 | 0.45226 | 11.35 | 87.397 | 0.088894 | 0.123900 | 3.94 | 42.259 | 626.6 | 0.45102 | 78.85 | 0.824 | 341.65 | 23.57 | 0.0813 | 1.469 |
| 27.9116 | 0.45072 | 11.33 | 89.691 | 0.091228 | 0.121566 | 3.92 | 41.336 | 643.1 | 0.44948 | 78.77 | 0.823 | 340.23 | 23.54 | 0.0813 | 1.468 |
| 28.1462 | 0.44917 | 11.32 | 91.986 | 0.093561 | 0.119232 | 3.90 | 40.418 | 659.5 | 0.44794 | 78.69 | 0.823 | 338.80 | 23.51 | 0.0812 | 1.466 |
| 28.3806 | 0.44763 | 11.31 | 94.280 | 0.095895 | 0.116899 | 3.89 | 39.505 | 676.0 | 0.44640 | 78.60 | 0.823 | 337.36 | 23.49 | 0.0811 | 1.464 |
| 28.6148 | 0.44608 | 11.29 | 96.575 | 0.098229 | 0.114565 | 3.87 | 38.597 | 692.4 | 0.44487 | 78.52 | 0.823 | 335.91 | 23.46 | 0.0810 | 1.462 |
| 28.8487 | 0.44454 | 11.28 | 98.869 | 0.100563 | 0.112231 | 3.85 | 37.694 | 708.9 | 0.44333 | 78.43 | 0.823 | 334.46 | 23.43 | 0.0809 | 1.461 |
| 29.0823 | 0.44300 | 11.26 | 101.163 | 0.102896 | 0.109898 | 3.84 | 36.796 | 725.3 | 0.44180 | 78.35 | 0.823 | 333.00 | 23.40 | 0.0808 | 1.459 |
| 29.3157 | 0.44146 | 11.25 | 103.458 | 0.105230 | 0.107564 | 3.82 | 35.903 | 741.8 | 0.44026 | 78.26 | 0.823 | 331.53 | 23.37 | 0.0806 | 1.457 |
| 29.5489 | 0.43993 | 11.23 | 105.752 | 0.107564 | 0.105230 | 3.80 | 35.014 | 758.2 | 0.43873 | 78.18 | 0.823 | 330.05 | 23.33 | 0.0805 | 1.455 |
| 29.7818 | 0.43839 | 11.22 | 108.047 | 0.109897 | 0.102896 | 3.78 | 34.131 | 774.7 | 0.43720 | 78.09 | 0.823 | 328.56 | 23.30 | 0.0804 | 1.453 |
| 30.0145 | 0.43685 | 11.20 | 110.341 | 0.112231 | 0.100563 | 3.77 | 33.252 | 791.1 | 0.43567 | 78.01 | 0.822 | 327.06 | 23.27 | 0.0803 | 1.451 |
| 30.2469 | 0.43532 | 11.18 | 112.636 | 0.114565 | 0.098229 | 3.75 | 32.379 | 807.6 | 0.43415 | 77.92 | 0.822 | 325.56 | 23.23 | 0.0802 | 1.448 |
| 30.4792 | 0.43378 | 11.17 | 114.930 | 0.116899 | 0.095895 | 3.73 | 31.510 | 824.0 | 0.43262 | 77.83 | 0.822 | 324.05 | 23.20 | 0.0801 | 1.446 |
| 30.7112 | 0.43225 | 11.15 | 117.224 | 0.119232 | 0.093562 | 3.71 | 30.646 | 840.5 | 0.43110 | 77.75 | 0.822 | 322.52 | 23.16 | 0.0799 | 1.444 |
| 30.9430 | 0.43072 | 11.13 | 119.519 | 0.121566 | 0.091228 | 3.70 | 29.787 | 856.9 | 0.42957 | 77.66 | 0.822 | 320.99 | 23.12 | 0.0798 | 1.442 |
| 31.1746 | 0.42919 | 11.11 | 121.813 | 0.123900 | 0.088894 | 3.68 | 28.933 | 873.4 | 0.42805 | 77.57 | 0.822 | 319.45 | 23.09 | 0.0797 | 1.439 |
| 31.4060 | 0.42766 | 11.10 | 124.108 | 0.126233 | 0.086560 | 3.66 | 28.083 | 889.8 | 0.42653 | 77.49 | 0.822 | 317.90 | 23.05 | 0.0796 | 1.437 |
| 31.6372 | 0.42614 | 11.08 | 126.402 | 0.128567 | 0.084227 | 3.64 | 27.239 | 906.3 | 0.42501 | 77.40 | 0.822 | 316.34 | 23.01 | 0.0794 | 1.434 |
| 31.8682 | 0.42461 | 11.06 | 128.696 | 0.130901 | 0.081893 | 3.63 | 26.399 | 922.7 | 0.42349 | 77.31 | 0.821 | 314.77 | 22.97 | 0.0793 | 1.432 |
| 32.0990 | 0.42309 | 11.04 | 130.991 | 0.133235 | 0.079559 | 3.61 | 25.565 | 939.2 | 0.42198 | 77.23 | 0.821 | 313.19 | 22.92 | 0.0791 | 1.429 |
| 32.3296 | 0.42156 | 11.02 | 133.285 | 0.135568 | 0.077226 | 3.59 | 24.735 | 955.6 | 0.42046 | 77.14 | 0.821 | 311.61 | 22.88 | 0.0790 | 1.427 |
| 32.5601 | 0.42004 | 10.99 | 135.580 | 0.137902 | 0.074892 | 3.57 | 23.910 | 972.1 | 0.41895 | 77.05 | 0.821 | 310.01 | 22.84 | 0.0788 | 1.424 |
| 32.7903 | 0.41852 | 10.97 | 137.874 | 0.140236 | 0.072558 | 3.55 | 23.090 | 988.5 | 0.41744 | 76.96 | 0.821 | 308.40 | 22.79 | 0.0787 | 1.421 |
| 33.0205 | 0.41701 | 10.95 | 140.168 | 0.142569 | 0.070224 | 3.53 | 22.275 | 1005.0 | 0.41592 | 76.88 | 0.821 | 306.78 | 22.75 | 0.0785 | 1.418 |
| 33.2504 | 0.41549 | 10.93 | 142.463 | 0.144903 | 0.067891 | 3.51 | 21.464 | 1021.4 | 0.41442 | 76.79 | 0.821 | 305.15 | 22.70 | 0.0784 | 1.415 |
| 33.4802 | 0.41397 | 10.90 | 144.757 | 0.147237 | 0.065557 | 3.50 | 20.659 | 1037.9 | 0.41291 | 76.70 | 0.821 | 303.51 | 22.65 | 0.0782 | 1.412 |
| 33.7099 | 0.41246 | 10.88 | 147.052 | 0.149571 | 0.063223 | 3.48 | 19.858 | 1054.3 | 0.41140 | 76.61 | 0.820 | 301.86 | 22.60 | 0.0780 | 1.409 |
| 33.9395 | 0.41095 | 10.86 | 149.346 | 0.151904 | 0.060889 | 3.46 | 19.063 | 1070.8 | 0.40990 | 76.52 | 0.820 | 300.19 | 22.55 | 0.0778 | 1.406 |
| 34.1689 | 0.40944 | 10.83 | 151.640 | 0.154238 | 0.058556 | 3.44 | 18.272 | 1087.2 | 0.40840 | 76.43 | 0.820 | 298.52 | 22.50 | 0.0777 | 1.403 |
| 34.3982 | 0.40793 | 10.81 | 153.935 | 0.156572 | 0.056222 | 3.42 | 17.486 | 1103.7 | 0.40690 | 76.34 | 0.820 | 296.83 | 22.44 | 0.0775 | 1.399 |
| 34.6274 | 0.40642 | 10.78 | 156.229 | 0.158905 | 0.053888 | 3.40 | 16.704 | 1120.1 | 0.40540 | 76.25 | 0.820 | 295.14 | 22.39 | 0.0773 | 1.396 |
| 34.8565 | 0.40492 | 10.75 | 158.524 | 0.161239 | 0.051555 | 3.38 | 15.928 | 1136.6 | 0.40390 | 76.17 | 0.820 | 293.43 | 22.33 | 0.0771 | 1.393 |
| 35.0855 | 0.40341 | 10.73 | 160.818 | 0.163573 | 0.049221 | 3.36 | 15.156 | 1153.0 | 0.40241 | 76.08 | 0.820 | 291.71 | 22.27 | 0.0769 | 1.389 |
| 35.3144 | 0.40191 | 10.70 | 163.112 | 0.165907 | 0.046887 | 3.34 | 14.390 | 1169.5 | 0.40091 | 75.99 | 0.820 | 289.97 | 22.22 | 0.0767 | 1.385 |
| 35.5432 | 0.40041 | 10.67 | 165.407 | 0.168240 | 0.044553 | 3.32 | 13.628 | 1185.9 | 0.39942 | 75.90 | 0.819 | 288.23 | 22.16 | 0.0765 | 1.382 |
| 35.7720 | 0.39891 | 10.64 | 167.701 | 0.170574 | 0.042220 | 3.30 | 12.871 | 1202.4 | 0.39793 | 75.81 | 0.819 | 286.47 | 22.09 | 0.0763 | 1.378 |
| 36.0008 | 0.39742 | 10.61 | 169.996 | 0.172908 | 0.039886 | 3.28 | 12.118 | 1218.8 | 0.39644 | 75.72 | 0.819 | 284.70 | 22.03 | 0.0761 | 1.374 |
| 36.2295 | 0.39592 | 10.58 | 172.290 | 0.175241 | 0.037552 | 3.26 | 11.371 | 1235.3 | 0.39496 | 75.63 | 0.819 | 282.91 | 21.97 | 0.0758 | 1.370 |
| 36.4582 | 0.39443 | 10.55 | 174.584 | 0.177575 | 0.035219 | 3.24 | 10.628 | 1251.7 | 0.39347 | 75.53 | 0.819 | 281.12 | 21.90 | 0.0756 | 1.366 |
| 36.6869 | 0.39294 | 10.51 | 176.879 | 0.179909 | 0.032885 | 3.22 | 9.891 | 1268.2 | 0.39199 | 75.44 | 0.819 | 279.30 | 21.83 | 0.0754 | 1.362 |
| 36.9155 | 0.39145 | 10.48 | 179.173 | 0.182243 | 0.030551 | 3.20 | 9.157 | 1284.6 | 0.39051 | 75.35 | 0.819 | 277.48 | 21.76 | 0.0751 | 1.357 |
| 37.1442 | 0.38996 | 10.45 | 181.468 | 0.184576 | 0.028217 | 3.17 | 8.429 | 1301.1 | 0.38904 | 75.26 | 0.818 | 275.64 | 21.69 | 0.0749 | 1.353 |
| 37.3729 | 0.38848 | 10.41 | 183.762 | 0.186910 | 0.025884 | 3.15 | 7.706 | 1317.5 | 0.38756 | 75.17 | 0.818 | 273.79 | 21.62 | 0.0746 | 1.348 |
| 37.6017 | 0.38700 | 10.38 | 186.057 | 0.189244 | 0.023550 | 3.13 | 6.987 | 1334.0 | 0.38609 | 75.08 | 0.818 | 271.92 | 21.55 | 0.0744 | 1.344 |
| 37.8305 | 0.38552 | 10.34 | 188.351 | 0.191577 | 0.021216 | 3.11 | 6.273 | 1350.4 | 0.38462 | 74.99 | 0.818 | 270.03 | 21.47 | 0.0741 | 1.339 |
| 38.0594 | 0.38404 | 10.30 | 190.645 | 0.193911 | 0.018883 | 3.09 | 5.564 | 1366.9 | 0.38315 | 74.90 | 0.818 | 268.14 | 21.39 | 0.0739 | 1.334 |
| 38.2883 | 0.38256 | 10.26 | 192.940 | 0.196245 | 0.016549 | 3.07 | 4.859 | 1383.3 | 0.38168 | 74.80 | 0.818 | 266.22 | 21.31 | 0.0736 | 1.329 |
| 38.5174 | 0.38109 | 10.22 | 195.234 | 0.198579 | 0.014215 | 3.04 | 4.160 | 1399.8 | 0.38022 | 74.71 | 0.818 | 264.29 | 21.23 | 0.0733 | 1.324 |
| 38.7466 | 0.37962 | 10.18 | 197.529 | 0.200912 | 0.011881 | 3.02 | 3.465 | 1416.2 | 0.37876 | 74.62 | 0.818 | 262.34 | 21.15 | 0.0730 | 1.319 |
| 38.9760 | 0.37815 | 10.14 | 199.823 | 0.203246 | 0.009548 | 3.00 | 2.775 | 1432.7 | 0.37730 | 74.53 | 0.817 | 260.38 | 21.06 | 0.0727 | 1.314 |
| 39.2055 | 0.37668 | 10.10 | 202.117 | 0.205580 | 0.007214 | 2.98 | 2.089 | 1449.1 | 0.37584 | 74.43 | 0.817 | 258.40 | 20.97 | 0.0724 | 1.308 |
| 39.4352 | 0.37522 | 10.06 | 204.412 | 0.207914 | 0.004880 | 2.95 | 1.408 | 1465.6 | 0.37439 | 74.34 | 0.817 | 256.40 | 20.88 | 0.0721 | 1.303 |
| 39.6650 | 0.37375 | 10.01 | 206.706 | 0.210247 | 0.002547 | 2.93 | 0.732 | 1482.0 | 0.37293 | 74.25 | 0.817 | 254.39 | 20.79 | 0.0718 | 1.297 |
| 39.8952 | 0.37229 | 9.97 | 209.001 | 0.212581 | 0.000213 | 2.91 | 0.061 | 1498.5 | 0.37148 | 74.15 | 0.817 | 252.38 | 20.70 | 0.0715 | 1.291 |

### Glossary of Abbreviations

Specific conditions:

P=pressure (N/m^{∧}2)
T=temperature (K)
V=specific volume (m^{∧}3/kg)
X=steam mass fraction (---)

Please consider if:

X=−2 fluid is water
X=0 fluid is water on the boiling curve
0<X<1 fluid is wet steam
X=1 fluid is steam on the saturated vapor line
X=2 fluid is superheated steam

then:

H=specific enthalpy (J/kg)
U=specific intrinsic energy (J/kg)
S=specific entropy (J/kgK)
C=fluid velocity (m/s)

Boiler feed water pump:

yPu=specific flow work of the feed-water pump (J/kg)
DhPu=specific enthalpy difference between feed-water pump exit and inlet (J/kg)
aPump=specific shovel work of the feed-water pump (J/kg)
EtaP=given (estimated) polytropic efficiency of the feed-water pump (%)

Water masses and discharge time:

MpW=water mass flow while steam valve is open (kg/s)
MW0=water mass within the cylinder when steam valve opens—occupies the entire cylinder volume except of the dead volume (kg)
MW1=water mass within the cylinder when steam valve closes (kg)
DeltMW=water mass leaving the cylinder while the steam valve is open (kg)
Time=time which passes by when steam valve is open and water mass DeltMW is expelled by the inflowing steam (s)

High pressure steam masses and load time:

MpDa=steam mass flow while steam valve is open and water mass DeltMW is expelled by the inflowing steam (g/s)
DelMDa=steam mass which flows in during the time when steam valve is open and water mass DeltMW is expelled by the inflowing steam (g)
MDtot=steam mass which fills up the dead volume with “fresh” steam (there is still the not expelled rest steam mass inside of the dead volume) (g)
MDampf=overall steam mass to fill the cylinder volume until steam valve closes—this steam mass has to be evaporated and to be condensed (g)
DTtot=time to fill the dead volume (s)
LTime=overall time to load the cylinder with the “fresh” steam MDampf (s)

Low pressure steam masses:

MmaxDa=max steam mass within the cylinder (g)
MExmDa=mass of wet steam inside the cylinder in BDC after blow down (g) MtotDa=mass of wet steam which is flowing into the dead volume where still the rest mass MDaRest is (g)
MDaRest=rest wet steam mass which is left inside the cylinder at TDC—dead volume—after the steam was expelled by the water piston (g)
DMAusb=blow down mass which leaves the cylinder when exhaust valve opens in BDC (g)
DMAuss=wet steam mass which will be expelled when water piston moves from BDC to TDC (g)
MDaKon=total wet steam mass which is to condense (g)

Mass flows, power output and input, heat flows:

MpW=water mass flow while steam valve is open (kg/s)
MpDa=steam mass flow while steam valve is open (g/s)
PTu=turbine power output while steam valve is open (W)
PTuis=isentropic turbine power output (no losses assumed) while steam valve is open (W)
PPum=needed pumping power (W)
QpDa=heat flow input to produce the needed steam (W)
QpKon=heat flow output to condense the steam and get rid of the losses (W)

Nozzle efficiency; turbine power; turbine efficiency:

EtaD=nozzle efficiency while steam valve is open (%)
PTu=turbine power output while steam valve is open (W)
EtaT=turbine efficiency while steam valve is open (%)

Power, work, heat flow, heat and efficiency without expansion:

PTu=turbine power output while steam valve is open (W)
WTu=turbine work while steam valve is open (J)
PPum=pumping power (W)
WPum=pumping work (J)
QpDa=heat flow to evaporate the feed-water (W)
QDa=heat to evaporate the feed water (J)
QpKo=heat flow output to condense the steam and get rid of the heat caused by losses while steam valve is open (W)
QKomax=heat output to condense the steam and get rid of the heat caused by losses while steam valve is open (J)
PNu=effective power output while steam valve is open (W)
WNu=effective work while steam valve is open (J)
Etath=thermal efficiency while steam valve is open (without considering steam expansion phase) (%)

Behavior before and during steam expansion:

Time=elapsed time from start of the cycle (s)
PvK=pressure in front of the (water) piston at specific time “Time” (bar)
MpW=water flow at specific time “Time” (kg/s)
MWEx=water which left the cylinder from cycle start till time “Time” (kg)
PNu=effective power output at specific time “Time” (W)
WNu=effective work from cycle start till time “Time” (J)
MpD=steam flow at specific time “Time” (g/s)
MDa=steam which entered the cylinder from cycle start till time “Time” (g)
LDa=length occupied by the steam from cycle start till time “Time” (mm)
PvD=pressure in front of the water nozzle at specific time “Time” (bar)
EtaT=turbine efficiency at specific time “Time” (%)
CnD=water velocity at nozzle exit (turbine inlet) at specific time “Time” (m/s)
CKo=water piston velocity inside the cylinder at specific time “Time” (m/s)
CvD=water velocity in front of the nozzle (nozzle inlet) at specific time “Time” (m/s)
vNDDa=specific Volume of wet steam related to the pressure in front of the water piston PvK at specific time “Time” (m^{∧}3/kg)
Epsi=steam expansion ratio vNDDa/vvK where vvK the specific volume in front of the water piston is when the piston just starts to move (---)
Ts(p)=boiling temperature related to the pressure in front of the water piston PvK at specific time “Time” (degrees Celsius)

Overall cycle results:

WNutz=effective work over cycle time (J)
PNutzm=time-averaged effective power output (W)
QDa=heat to evaporate the feed water over cycle time (J)
QpDam=time-averaged heat flow needed to evaporate all feed water (W)
QKomax=heat output over cycle time to condense the steam and get rid of the heat caused by losses (J)
QpKom=time-averaged heat flow output to condense the steam and get rid of the heat caused by losses (W)
MW=by the water piston moved and expelled water mass during cycle run (kg)
MDampf=overall steam mass to fill the cylinder volume until steam valve closes—this steam mass has to be evaporated and to be condensed (g)
WTime=working time of the water piston during cycle run (s)
ETath=thermal efficiency for the full cycle (%)
VVTu=turbine work over cycle time (J)
PTum=time-averaged turbine power output (W)
WTuis=isentropic turbine work (no losses assumed) over cycle time (W)
PTuism=time-averaged isentropic turbine power output (no losses assumed) (W)
EtaTm=over cycle time averaged turbine efficiency (%)

Behaviour during blow down and refilling:

Time=elapsed time from start of the refilling (s)
PvK=pressure in front of the (water) piston at specific time “Time” (bar)
MpW=water flow at specific time “Time” (kg/s)
MWRe=water which entered the cylinder from refill start till time “Time” (kg)
VWa=volume occupied by refilled water at time “Time” (m^{∧}3)
VDa=volume stilled occupied by wet steam at time “Time” (m^{∧}3)
MpD=steam flow at specific time “Time” (g/s)
MDa=steam which still is inside of the cylinder at “Time” (g)
LWa=water-level inside the cylinder from refilling start till time “Time” (mm)
PvD=pressure in front of the steam nozzle at specific time “Time” (bar)
TvKD=steam temperature in front of the water piston at specific time “Time” (C)
XvK=steam mass fraction front of the water piston at specific time “Time” (---)
CnD=steam velocity at nozzle exit at specific time “Time” (m/s)
CvD=steam velocity at nozzle entrance at specific time “Time” (m/s)
C-Pi=velocity of the water piston surface in the cylinder at specific time “Time” (m/s)
CWin=water velocity inside the water pipe at specific time “Time” (m/s)

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for providing energy to a defined space, the method comprising:
receiving thermal energy from a solar power source at a solar boiler;
generating steam from the thermal energy using the solar boiler;
driving one or pistons of a steam engine with a pressure from the steam, the steam engine outputting a first waste heat; and
receiving the first waste heat from the steam engine at a chiller, the chiller generating conditioned air from the first waste heat.

2. The method of claim 1, wherein the chiller outputs a second waste heat, the second waste heat received at a hot water tank, the hot water tank generating a hot water supply from the second waste heat.

3. The method of claim 1, wherein the first waste heat is generated from the steam exiting the steam engine at a low pressure.

4. The method of claim 1, wherein the first waste heat is generated from leftover heat from the solar boiler.

5. The method of claim 1, wherein the thermal energy is supplemented with heat generated from a supplemental power source.

6. The method of claim 5, wherein the supplemental power source includes a combustion boiler.

7. The method of claim 6, wherein a rate of delivery of an energy input into the combustion boiler is varied to maintain a preset level of heat output.

8. The method of claim 7, wherein the energy input includes air and fuel and the preset level of heat output is maintained based on an air-to-fuel ratio.

9. The method of claim 1, wherein at least one of unused waste heat or unused cold is output into an in-ground heat exchanger.

10. A system for providing energy to a defined space, the system comprising:
a first boiler having a first heat exchanger generating a first heat output from a first energy source having a first temperature;
a second boiler having a second heat exchanger generating a second heat output from a second energy source having a second temperature, the second heat output supplementing the first heat output to form a two-stage boiler having a cogenerated heat output, the second heat exchanger being disposed above the first heat exchanger, the first energy source being different from the second energy source and the first temperature being lower than the second temperature; and
a piston steam engine driven by steam generated by the cogenerated heat output.

11. The system of claim 10, wherein the first energy source is solar energy and the second energy source is combustion energy.

12. The system of claim 10, wherein a combustion zone is integrated into the second heat exchanger.

13. The system of claim 10, wherein waste heat generated by at least one of the two-stage boiler or the steam engine is output into a chiller, the chiller generating conditioned air from the waste heat.

14. The system of claim 13, wherein waste heat generated by the chiller is output into a hot water tank, the hot water tank generating a hot water supply from the waste heat generated by the chiller.

15. The system of claim 10, wherein the piston steam engine drives a generator, the generator outputting electricity.
